(19) United States
(12) Patent Application Publication
(10) Pub. No.: US 2014/0136305 A1
(43) Pub. Date: May 15, 2014

(54) QUALITY CONTROL MANAGEMENT SYSTEM

(71) Applicant: Marc Blumenthal, Portsmouth, NH (US)

(72) Inventor: Marc Blumenthal, Portsmouth, NH (US)

(21) Appl. No.: 13/828,269

(22) Filed: Mar. 14, 2013

Related U.S. Application Data
(60) Provisional application No. 61/726,420, filed on Nov. 14, 2012.
(60) Provisional application No. 61/740,096, filed on Dec. 20, 2012.

(51) Int. Cl. G06Q 30/02

(52) U.S. Cl. CPC G06Q 30/0217
USPC 705/14.19

(57) ABSTRACT

The present invention relates to systems and methods for providing quality review of products and services using computer implemented technology. A wireless mobile device can be used to access information regarding products and services and enables the user to provide quality review data regarding those products and services. The reported user information regarding the quality of goods or services can be provided in real or near-real time and stored in a database or data warehouse to provide business intelligence for enrolled businesses.

### CROSS REFERENCE TO RELATED APPLICATIONS

The present application claims priority to U.S. Application No. 61/726,420 filed on Nov. 14, 2012 and also claims priority to U.S. Application No. 61/740,096 filed on Dec. 20, 2012, the entire contents of these applications being incorporated herein by reference.

### BACKGROUND OF THE INVENTION

For all businesses, customer and employee loyalty translates to business success. To succeed at customer and employee loyalty, a business must succeed at customer and employee retention. To succeed at customer and employee retention, a business must succeed at customer and employee satisfaction. To understand such satisfaction, a business must have in place some method for obtaining “timely” quality control feedback in connection with their product(s) and or service(s) from both their customers and their employees.

Currently there are two types of customer feedback systems: “public and private”. The public or B2C (Business to Consumer) systems promote customer reviews to the world leaving a business to pick up the “bad news” after the fact when it is too late to make changes to improve quality before the public relations damage is done. The second type of program is the private or B2B (Business to Business) customer and employee feedback systems initiated by the businesses themselves. These systems have remained almost unchanged for over 100 years; a combination of in person or phone interviews or the submission of a hard copy form by mail or to a “suggestion” box at a business location. These systems suffer from “social intimidation”: most customers and employees are unwilling to speak out directly to a manager or other business personal to tell them what is wrong with their product or service. More recently some businesses have reverted to a questionnaire sent to a customer. But in all cases these systems provide businesses with stale and aged feedback often more than 24 or 48 hours old and both customers and employees are not given any incentive to fill out customer surveys.

Those surveys which are submitted by hard copy and typically contain negative feedback, are all too often intercepted by service staff or middle management thereby preventing upper management or business owners from getting important customer feedback. Employees who are identified with suggestions that are not flattering to an immediate supervisor often will feel the heat of retribution, and consequently, when faced with the choice of making a suggestion, they chose not to. Recently many businesses have developed customer loyalty programs as a way to reward and retain customers for their patronage, but these do not reward customers for product or service quality feedback, or reward employees for customer feedback about outstanding employee service. Consequently, a need exists to provide improvements in providing feedback regarding a business's products and services which preserves the anonymity of, and provides incentive for, both customers and employees to participate.

### SUMMARY OF THE INVENTION

The present invention relates to systems and methods employing communication of quality control information to businesses, public institutions, charitable organizations, and other operating entities that provide products and/or services to others. Systems in accordance with preferred embodiments of the invention provide for the review of a product or service that enables collecting and proactively following up on customer responses with respect to a transaction involving the purchase of products and/or services sold by such entities. Preferred embodiments include a customer or employee feedback system that utilizes wireless communication technology and machine readable labeling or tagging to capture real time or near real time customer feedback from a significantly greater population of customers. This is accomplished by transforming customers and employees of entities that provide products or services into a “community” who are motivated by both compensation that is obtained through “anonymous” participation and a desire to help businesses improve their products and services through an enhanced system of customer and employee review. This system includes a quality control monitoring system which can be utilized by a wide variety of service oriented businesses to improve quality control of the services and/or products they provide.

A preferred embodiment of the invention includes a mobile communication device application and an internet website linked to at least one database in which business, employee and consumer data are stored. There are several important players, namely, the users, the businesses they utilize and the employees that make the business work. The system enables a symbiotic relationship between businesses, their employees and their customer base. These users help businesses improve the quality of the products that the users buy and the service of the employees that deliver them. Businesses want to reward and maintain a connection with customers and employees who provide invaluable quality control information. Unlike prior customer survey processes, the present invention provides a user initiated process to provide review data regarding a product or service.

Preferred methods of using this system include a plurality of review options available to the user in which a wireless mobile communication device such as a cellular telephone, smartphone or tablet, for example, in which a software application has been stored in the mobile device memory, the device being operative to transmit information entered by the user regarding products or services. These devices can be connected to a quality review system server by a wireless communication network. The server is connected to a memory system such as a data warehouse in which business data, user data and the review data they generate, are stored. In a preferred embodiment, each user has an account on the system and businesses can be enrolled so that review data for each business entity is stored in the system data warehouse. Both users and businesses can access their account information using a public access network such as the internet. The system website can also be accessed using a system icon that can be viewed on the user's mobile device screen or on a computer screen. Businesses can utilize business intelligence software tools to access, organize and report on review data acquired over time regarding recorded transactions.

A preferred embodiment can involve a product or service that is acquired at a specific geographic location or “point-of-sale” (POS). Examples of a POS acquisition undergoing customer review can include retail stores, restaurants, banks, hotels or other product or service providers associated with a specific geographic location, where a user employs a mobile wireless device to identify the POS location, the product or service, the business offering the product or service and for entry of the review data by the user. The location can be established using GPS data from the mobile wireless device or by scanning a tag or code at the location using a machine readable code or tag, or a near field communication feature of the mobile wireless device. The tag can be easily recognized by each user as a system icon (“hot link”) can be mounted on a display housing which identifies the system affiliation with the business. The display housing can be a passive or an active electronic display. The display housing can indicate that a scan has been conducted (such as with an audible or visual signal), or the wireless device can also perform this function.

Another preferred embodiment provides review data for products or services that are not geographically associated with a particular point of sale (i.e. a non-POS review process). This can occur when products or services are purchased using the internet or other communication network, for example, such as airplane tickets, theaters, at lectures or classrooms, or at athletic or sporting events. The product or service can also comprise a quality review process for electronic media accessed by a user via an electronic media device such as a movie theater, a television, a computer or portable wireless technology including tablet devices or smartphones. The review process can be initiated using a mobile communication device of the user in which the device “bumps” another device to open the application and identifies the media content to the mobile device, or employs a near-field communication link to perform this function to enable the user to obtain the proper review format for entering review data. The review data can also be entered through an internet portal at a business website using a virtual tag or “hot link” icon.

A preferred embodiment of the system enables a user to scan a consumer product that is labeled with a code or RFID tag to perform a review of the product. In this embodiment, the purchased product can have a tag or code on the product package, or the product itself, that can be scanned by the user using their mobile device. Another preferred embodiment enables the user to review a product or service at a non-point-of-sale location. In this embodiment, a user can scan a code, tag or electronic icon at a non-point-of-sale location to identify a business entity, or alternatively, can enter a business location by a code or by utilizing a GPS location of the mobile device. Scanning a code can operate to open the application on the user's device. Once the correct business entity is confirmed, the user can enter the review of the product or service as described generally herein.

In another preferred embodiment, the user can be an employee that wishes to make suggestions to their employer regarding the business they operate. This enables a confidential submission to the employer in which the employee can remain anonymous and be compensated for valuable suggestions. This can be done by the employees using a web enabled application through a secure “suggestion box” or using a poster within an embedded system RFID tag, or by an internet portal having a virtual tag or icon that employees can activate. An employee's name tag or business identification card can also include a tag to activate the system. The employee remains anonymous in this process. The submission can be acknowledged by a “thank you” message and graded to assign the appropriate compensation feature.

Another preferred embodiment involves situations in which a user desires to provide a review or feedback on a product or service of an unenrolled business or organization. In this embodiment, the user can identify the business or organization by GPS coordinates and/or a mapping program and then provides a review of the transaction or event using their communication or computing device. The system server receives the review data and searches a database in which information regarding unenrolled businesses or organizations is stored. The system can select a method for communication with the unenrolled business or organization and an attempt can be made to enroll the entity as an enrolled business having a system business account. This process replaces existing techniques such as writing letters, telemarketing calls or phone calls to complain about service.

Both businesses and users can access account information, enroll in the system or modify account information using a system website that can be accessed by any networked computer having access to the internet. The networked computer can also include a scanner such as a near field communications device which can be mounted within a laptop computer, for example. Both businesses and users have password enabled access to secure account information on the system database. Users also have their review data evaluated on a scale, or graded, so that the reliability of user data can be accumulated over time. This can be used to classify users to promote greater rewards for accuracy of the review data. This enables businesses to reward consistent customer participation with appropriate rankings and rewards made available only to certain ranked classes of users.

### BRIEF DESCRIPTION OF THE DRAWINGS

FIG. 1A illustrates a quality review system in accordance with preferred embodiments of the system;

FIG. 1B illustrates a mobile wireless device depicting a scannable code;

FIG. 1C illustrates software modules operated by the system in accordance with preferred embodiments of the invention;

FIGS. 1D-1F illustrates a method for performing quality review of a service provider in accordance with a preferred embodiment of the invention.

FIG. 1G illustrates a data warehouse interface system for processing and storing quality review data;

FIG. 1H illustrates an example of a product bearing a tag, such as an RFID tag, in accordance with embodiments of the invention;

FIG. 2 is a process sequence illustrating a quality review process at the point of sale in accordance with preferred embodiments of the invention;

FIG. 3 illustrates an icon display of a mobile wireless device including a “QC Check” icon;

FIG. 4 illustrates displayed information confirming the opening of the review application with additional selectable icons;

FIG. 5 illustrates a displayed scan button that a user can select to initiate a scan;

FIG. 6 illustrates an alternative method that queues the user to perform an RFID identification;

FIG. 7 illustrates a display confirming a point-of-sale location and an option to review a transaction by voice or text;

FIG. 8 illustrates a displayed review screen which includes selectable review options for the user;

FIG. 9 illustrates a second displayed review screen including second selectable review options;

FIG. 10 illustrates a display of compensation for review of the transaction;

FIG. 11 illustrates a display of an optional scannable code to complete a transaction at the point-of-sale;

FIG. 12 is a process sequence illustrating quality review for a consumer product in accordance with preferred embodiments of the invention;

FIG. 13 illustrates a display for user entry of product identification data;

FIG. 14 illustrates a display of a recall notification for a purchased product;

FIG. 15A is a process sequence illustrating conducting quality review of a transaction not at a point-of-sale in accordance with preferred embodiments of the invention;

FIGS. 15B-15C illustrate scanning of a tag after using a service such as a flight at an airport;

FIGS. 15E-15F illustrate a system for providing customer review data using a television, computer or other electronic media device in accordance with preferred embodiments of the invention;

FIG. 16 is a process sequence illustrating quality review for an employee in accordance with preferred embodiments of the invention;

FIG. 17 illustrates a display of a review format for an employee to submit a suggestion to an employer by voice or text;

FIG. 18 illustrates a display in which the employee or user can select a category for review;

FIG. 19 illustrates a display in which an employee or user can enter a text description to provide review data;

FIG. 20 is a process sequence for quality review of a business that is not enrolled in accordance with preferred embodiments of the invention;

FIG. 21 illustrates a display screen upon accessing the review system website;

FIGS. 22A-22F illustrate display screens in which a user can access their account features in accordance with preferred embodiments of the invention;

FIGS. 23A-23B illustrate display screens in which enrolled business can access business account features in accordance with preferred embodiments of the invention;

FIG. 24 illustrates a display screen in which an employee user can access an employee account of an enrolled business;

FIG. 25 illustrates post submission processing of review data in accordance with preferred embodiments of the invention.

### DETAILED DESCRIPTION OF THE INVENTION

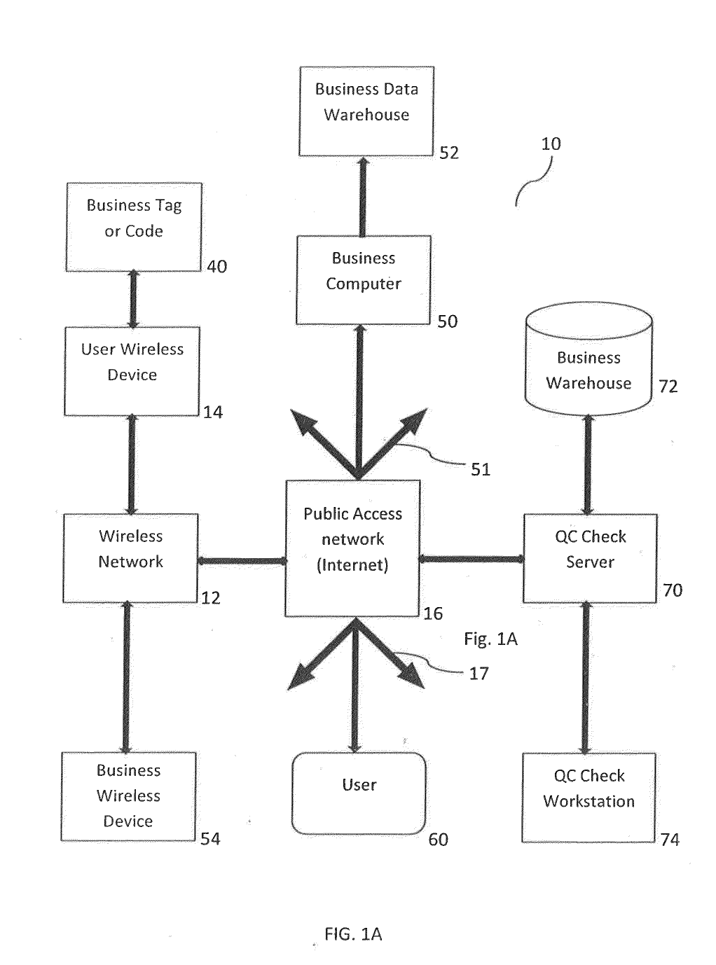

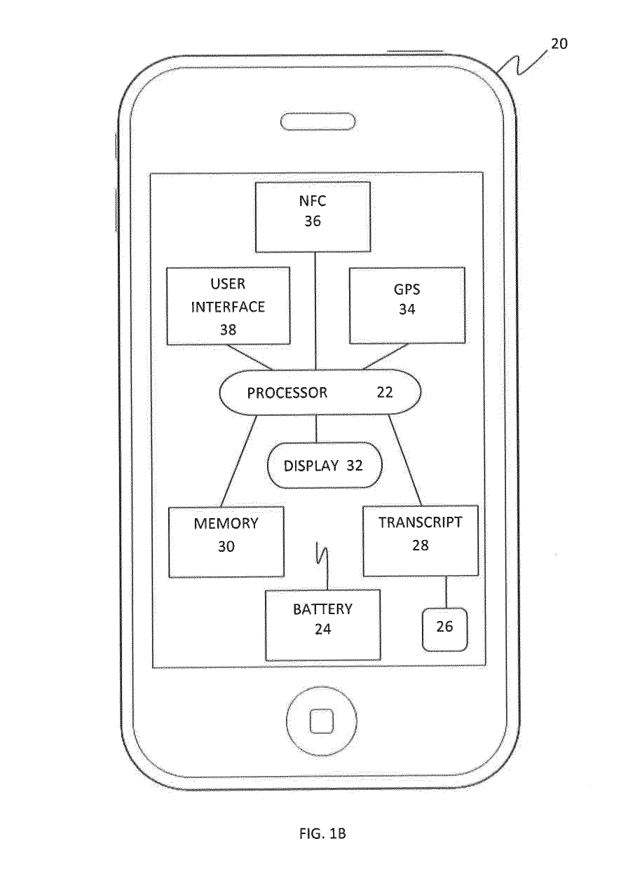

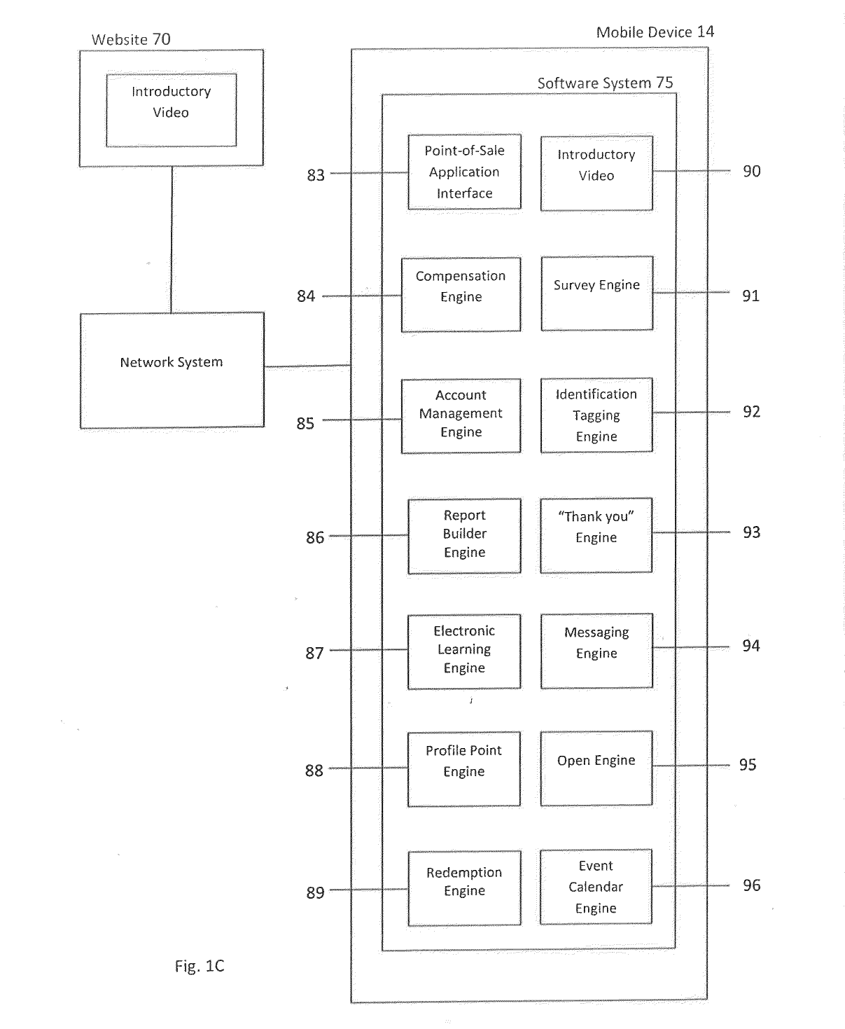

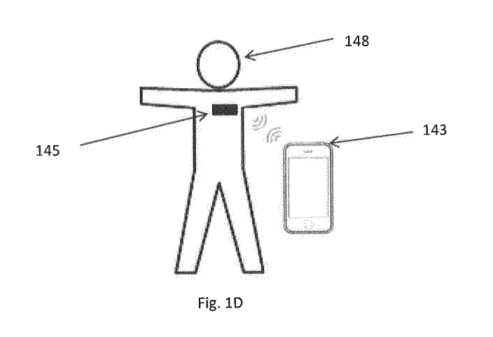

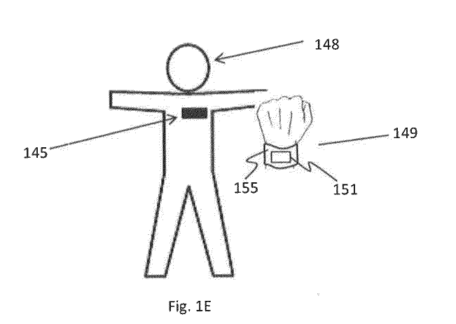

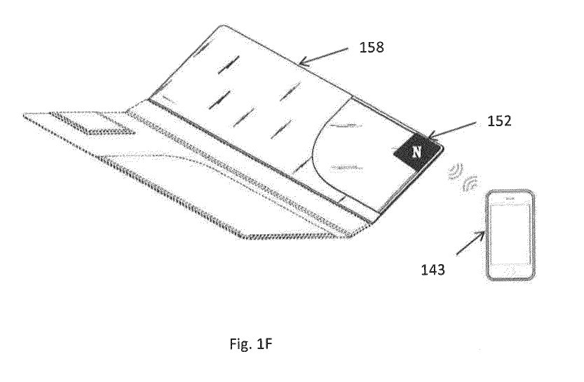

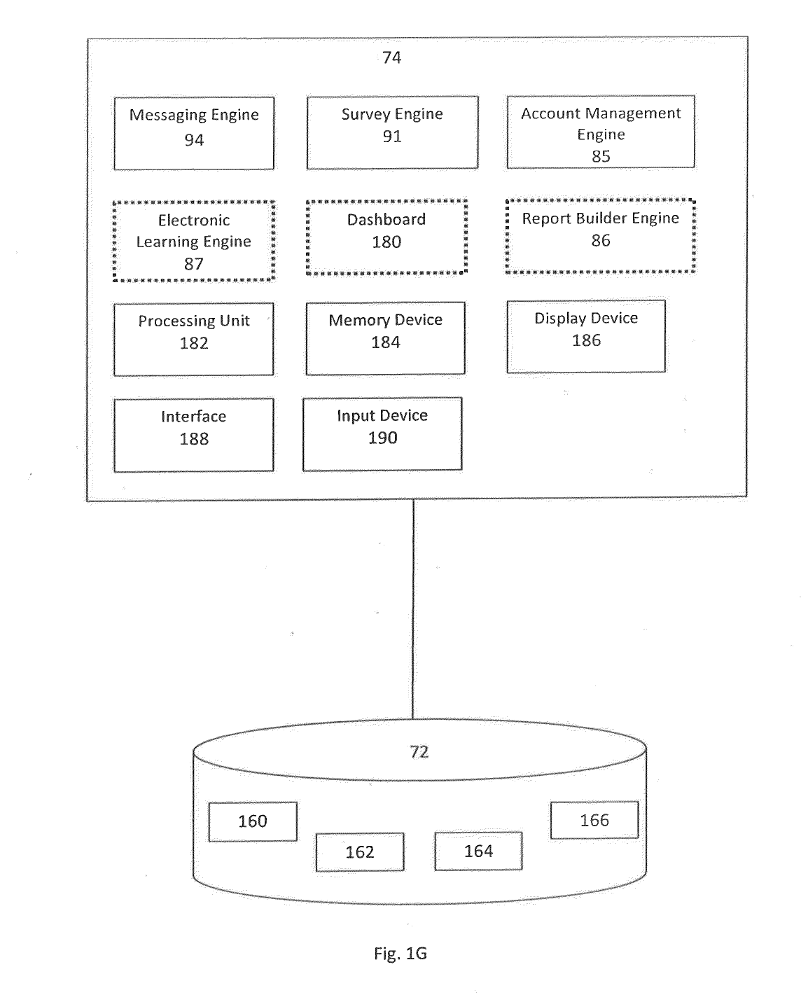

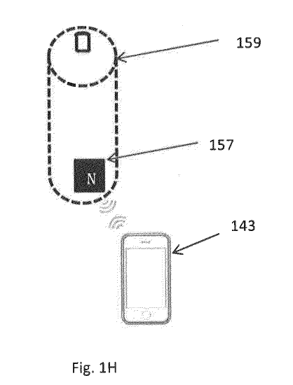

A system 10 illustrating a preferred embodiment of the invention is shown in FIG. 1A. The system 10 includes a wireless network 12 that a plurality of users, such as consumers of products and/or services, can access using a wireless mobile device 14 such as a cellular telephone, smartphone, tablet, laptop or other handheld portable communications device. The wireless network 12 or other wireless communication links can be used to connect the user to a public access network 16 such as the internet. The system includes a system server 70, a system workstation 74 and a data storage system such as a data warehouse 72. Business can participate or enroll using their internal computer system 50 and data storage 52 resources. A plurality 17 of users 60 can connect using the WAN or public access network which can also be connected to a plurality of entities 51, each accessing the system by a computing device.

Mobile wireless devices 14, such as the device 20 shown in FIG. 1B, are battery powered devices that have a data processor 22, a battery 24, an antenna 26, a display 32, a camera and transceiver 28 enabling transmissions of voice and/or data, a memory 30 for storing data and software applications or “Apps” that can be executed by the user with a user interface 38 such as a keyboard or touchscreen operated graphical user interface. The device 20 can further include a near field communication device 36 (NFC) or contactless reader components that enables the user to scan a tag, code or kiosk 40 that identifies the location, business entity, or product to be reviewed. The NFC device can be integrated into a chip package using, for example, the integrated circuit packages for mobile applications available from NXP Semiconductors, such as the PN65N, that operates for a variety of radio frequency (RF) protocols and includes a controller that integrates additional mobile phone functions. A global positioning system (GPS) device 34 can enable the user to identify the device location which the software then uses to identify the business or vendor which the user seeks to review.

Any individual who elects to download a quality review application in accordance with the invention for their wireless device is automatically considered to be a user. A user can receive compensation or “rewards” for their participation in the program. Upon loading the application for their smart phone, they are asked to register once with their internet address, gender, age, income bracket, name and address. The user also selects a unique password to update their information and access their rewards account. The user can view the rewards they have received in return for providing their customer feedback to enrolled businesses and for being a valued customer.

All enrolled businesses can also be highlighted on web-enabled maps for ease of identification when the user is in close proximity to an enrolled business location. At checkout at any enrolled business, the user can scan display at the business location that houses an impeded RFID tag and printed code of the specific business. The scan initiates an interactive sequence in which the user answers up to 5 (or more) simple questions. Each question can be answered within a range of 1 (poor) to 5 (excellent) options, for example. A more in depth optional survey can be offered for additional reward points if a user has provided a negative review, for example. Compensation can be equal or superior to any that is given to existing customers and superior to any “shotgun” discounts or coupons distributed by entities. Rewards can be retrievable at the POS (point-of-sale) as coupons or cash credits immediately debited off the user's bill, or non POS locations as credits to be posted at the user's account for conversion to coupons, loyalty reward program's points or miles, or “cash” for purchase of goods and services offered at the system's online store. The user can obtain rewards according to the rewards model selected by the business website. The user is able to see the rewards totals they have earned with the system every time they access their account. The business can see the amount of rewards they have paid out for obtaining users' real time information such as quality control feedback.

Any business that elects to have real time quality control feedback from its customers and employees can elect to participate in the system. To participate, a business simply accesses the website and registers by providing specific information about their company. Confidentiality of both user and business information by using coded or password access to the user accounts and the enrolled business accounts that can be accessed using the system server. The system provides each registered business with a “menu” focused on providing their type of business with recommendations for a variety of services for customer promotions, customer retention, employee service improvements and quality control feedback.

Business sectors include: restaurants, hotels and guest houses and retail establishments including but not limited to supermarkets, gas stations, department stores, specialty retailers, hair dressers, auto dealers and mechanics, pharmacies, government agencies, transportation (airlines, trains, busses and taxis), car rental agencies, universities, professional services such as attorneys, accountants, public service agencies and more.

The business menu includes several components including: quality control, customer connection/retention and employee connection and retention. The management of any business can access all user information and the consolidation of that information according to a variety of sub menus within minutes of the input of that information. So, for example, a restaurant can access all aspects of its quality for a lunch time meal service within minutes of the completion of the meal service. An airline can monitor the quality of a specific flight within minutes of the landing of that flight and so forth. The business can customize its selection of questions from the review or survey menu and change it as needed. A consolidated summary for an individual business, or business with several locations or franchises, are kept within the database or data warehouse. Consolidated on line reports can be accessed to provide business management and ownership with daily, weekly, monthly and yearly comparisons with graphs and trend lines illustrating improvement or decline.

The business can select from a wide variety of “customer connect” and “employee connect” emails from the business website. These are posted to the customers' account and alert the customer or employee that there are awards or offers that the business has made available. The user can elect whether they want these offers emailed to their email address through the user website or posted to their account. The business can select from a large offering of recommended customer or employee “connect” promotional features or customize their own. For example, promotional options for a restaurant can include a birthday card with a free dessert coupon, a special discount to sample a new menu and provide review information. A hair stylist might include a promotion for a free scalp massage with a color treatment, a gas station a free coffee, or an airline a free bag at check in. A large company might offer employees innovation of the month awards to employees with the best idea for customer improvement, for example. These promotions are a way for the business to connect with their preferred customer base including those customers who provide the business with valuable quality control information. These promotions can be issued to the user over and above the rewards they receive for providing their feedback. The business can also elect to utilize the system to manage business to business communications.

Once enrolled in the system, the business receives all customer feedback using business intelligence software to access data stored in the data warehouse. The software can generate reports for the business that can perform a number of options, including tracking the performance of enrolled businesses such as retailers and provide electronic learning options for training of business staff based on review data.

The software system 75 shown in FIG. 1C includes a plurality of modules including a point-of-sale (POS) application interface protocol (API) using standard metadata/XML formats compatible with retailer POS systems. The system 75 can utilize a compensation engine 84 that attributes cash, points, rewards or other compensation or communication features to specific user accounts for survey responses or “reviews.” A survey engine 91 is included that selects from a plurality of survey or review formats. Survey or review data are tagged or labeled with a unique identifier so that they are associated with the correct business and user. The software system further includes an introductory video 90 to users that explains how the system operates. This video can also be accessed through the system website 70. An account management engine 85 can be used to enroll businesses and that add (or subtract) retail locations; a report builder engine 86 enables enrolled businesses to construct customized reports; an electronic learning (e-learning) engine 87 provides on-line training for enrolled businesses and their employees; and an identification tagging engine 92 that serves to identify retail locations and transactions by a machine readable code (NFC link bar code, RFID tag, QR code) using a camera or scanning technology; an event calendar engine 96 can be used to schedule events that can link to network accessible calendar software systems; a “thank you” engine 93 for communicating with enrolled business employees or unenrolled businesses; a messaging engine 94, a profile point engine 88, a coupon (Qpon) engine 95, and a redemption engine 89 can also be utilized.

An embodiment uses a manual approach at the point-of-sale where the user accesses the phone or mobile device application. The phone application can trigger the GPS identification of the business. The application asks for manual input of point-of-sales number from a printed bill identifying the business, and optionally, the specific transaction bill, and produces survey data via customer preference using either a Q-texting survey interface, or a Q-voice survey interface.

A preferred embodiment uses a NFC (near field communication) system in which an NFC device at the point-of-sale opens the system (QC) application. The device receives the NFC signal with application location and point-of-sale bill number entered by a point-of-sale person. This embodiment can use an NFC device that has a key pad and sends phone, business location and point-of-sale number. This also produces survey data via customer preference either by a Q-texting survey interface or by a voice survey interface available through the mobile device application.

A further embodiment uses an option in which a user can provide quality review data of a service person 148 such as a waiter, policeman, clerk, stewardess, etc. The service person 148 can be identified by employee number or name, for example, or alternatively, by a scannable code or RFID tag that can be mounted to a name tag or identification card 145 that is scanned by the user with their mobile communication device 143, as shown in FIG. 1D and as described herein. Shown in FIG. 1E is an embodiment in which a body worn device, such as a wrist watch 149, or glasses that can include an NFC device 155, a display 151 and that can enter and communicate review data as described herein. The user can record quality review data using the device that can be transferred immediately or stored for later delivery to the system server. In another embodiment shown in FIG. 1F in which a server at a restaurant or other business providing a service can present an invoice to a customer using a folder 158 including an NFC device 143 to connect with a mobile device as described herein.

In both cases, data with survey results are delivered to a business database for reports generation, email action to the user or employee or to business management. The rewards, posting of cash, coupon or acknowledgement can also be stored in the business database or system data warehouse. The system can use a computing device 74, as shown in FIG. 1G, that can be linked to the data warehouse 72 which can have segmented storage elements for the review data 160, business account data 162, user account data 164 and system operations data 166, for example. The computing device 74 can access and utilize engine modules such as the survey engine 91, the messaging engine 94, the account management engine 85, the report builder 86 and the learning engine 87, for example. The computing device 74 can include an input device 190, data processor 182, memory 184, and a display that uses dashboard 180. The interface 188 can utilize a standard communications port to connect to a network.

A preferred embodiment of the invention is illustrated in connection with FIG. 1H in which a mobile device 143 communication with an identification tag 157 on a purchased product 159 or the product packaging to initiate a review of the product using a mobile communication device. The product can also be scanned with a scanning device connected to a computer operated by the user. Business entities selling or shipping such products in connection with internet sales can also use such tags for product and warranty tracking purposes as well as quality review management.

Businesses can build and strengthen customer loyalty, retention and community, obtain unbiased real time quality control information, build and strengthen loyalty, retention and community of those workers who provide direct service to their customers and are the face of the business, and award customer loyalty through coupons aimed at building customer retention. Users earn rewards by helping a business improve their quality control and their customer experience, and can enable a business to thank an employee for providing improved customer service.

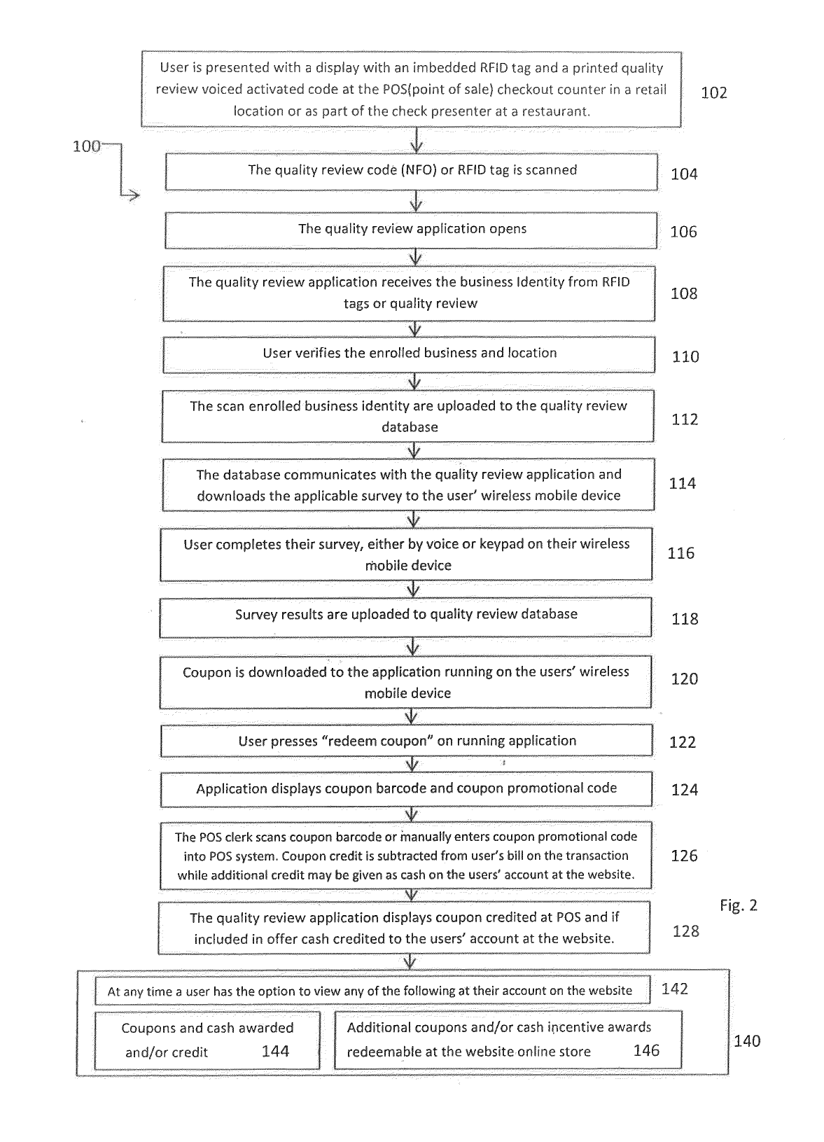

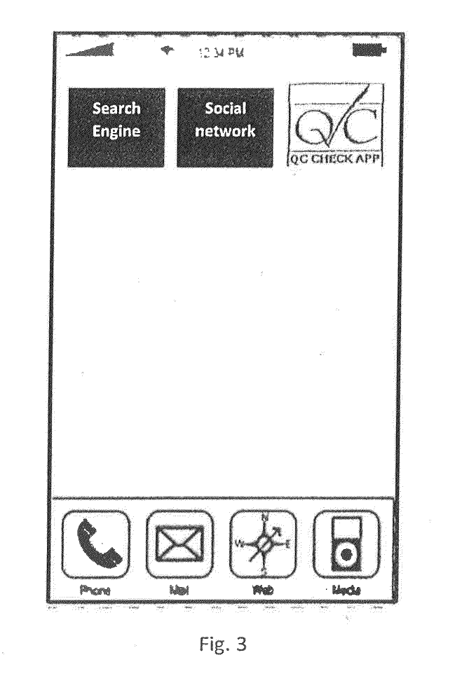

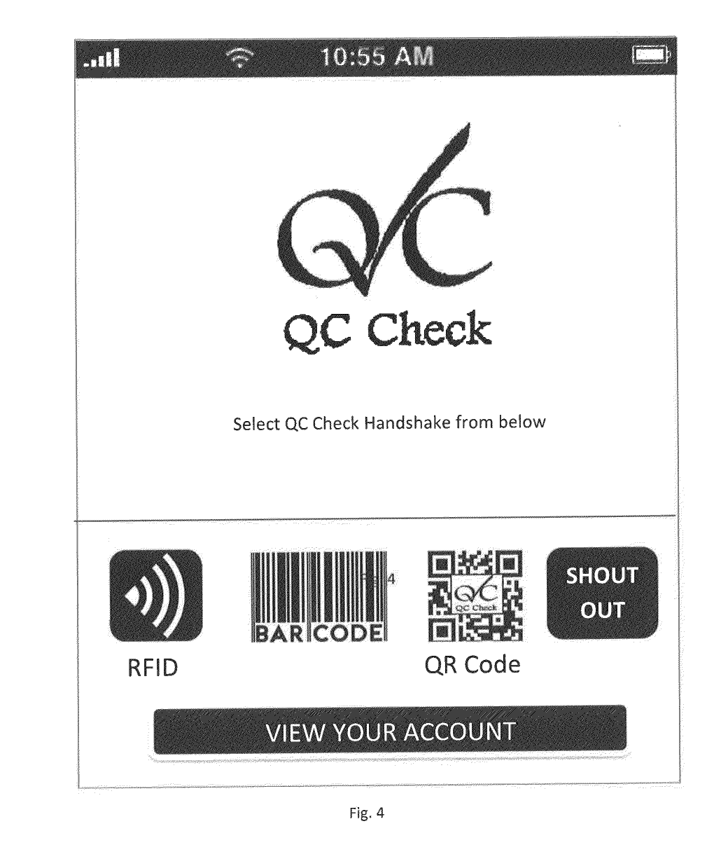

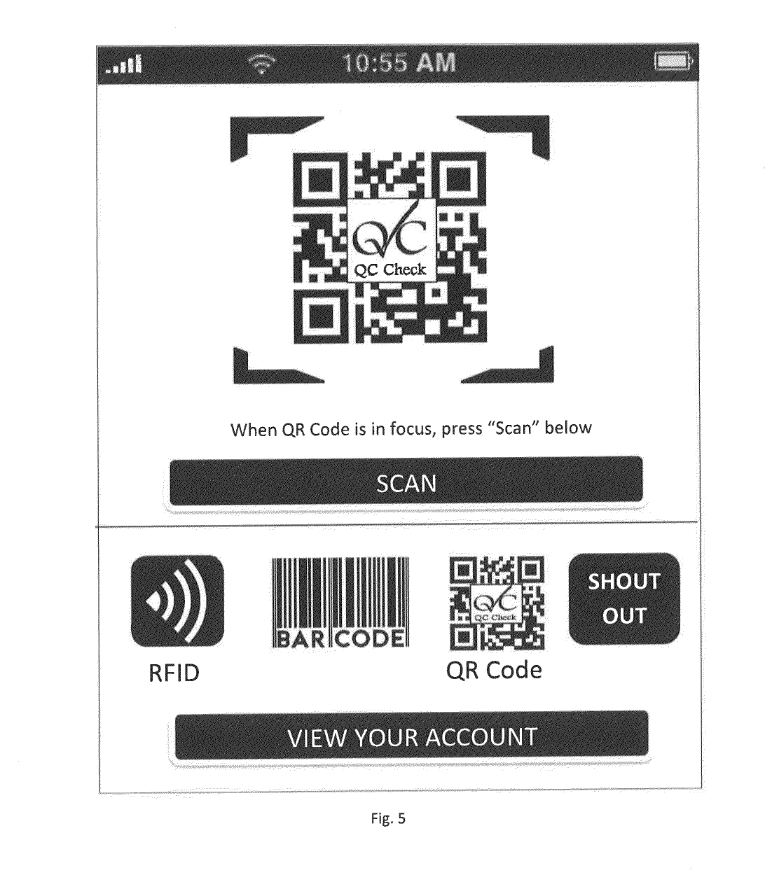

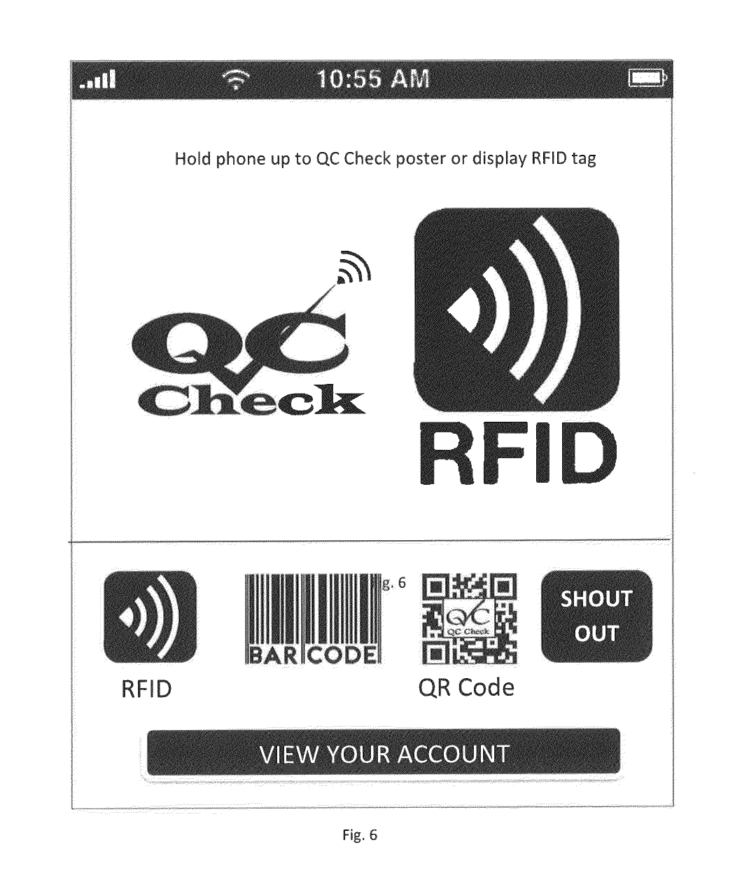

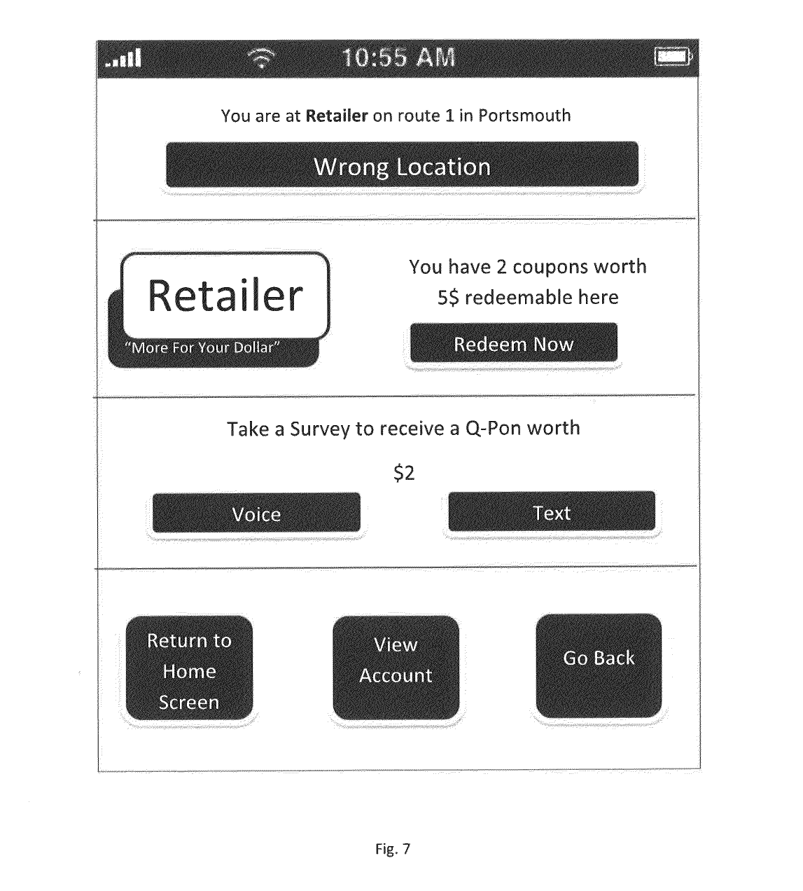

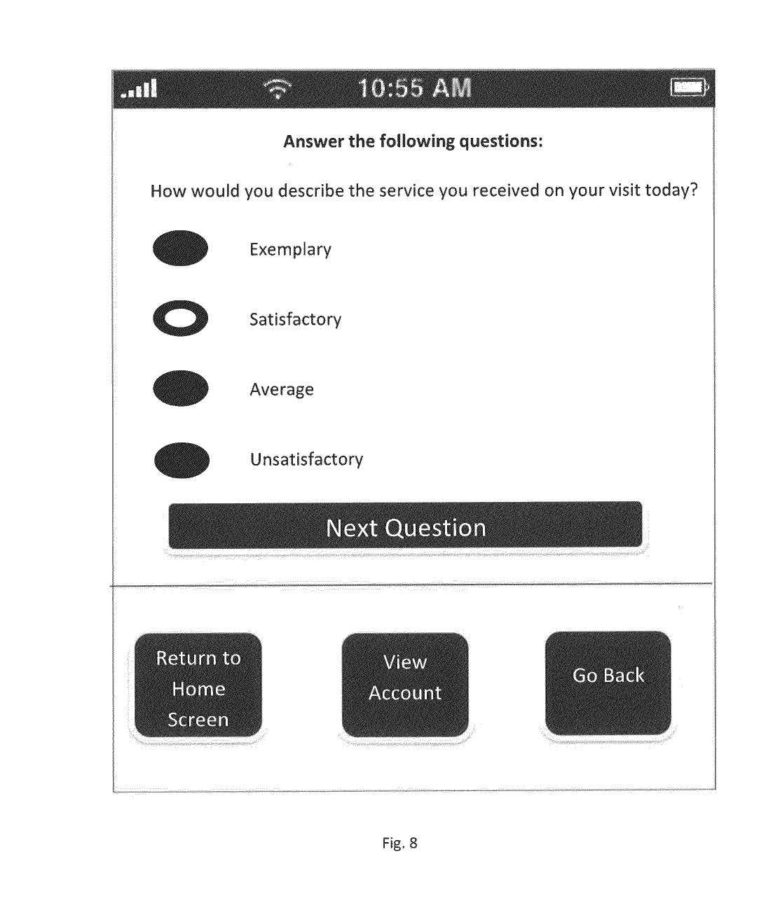

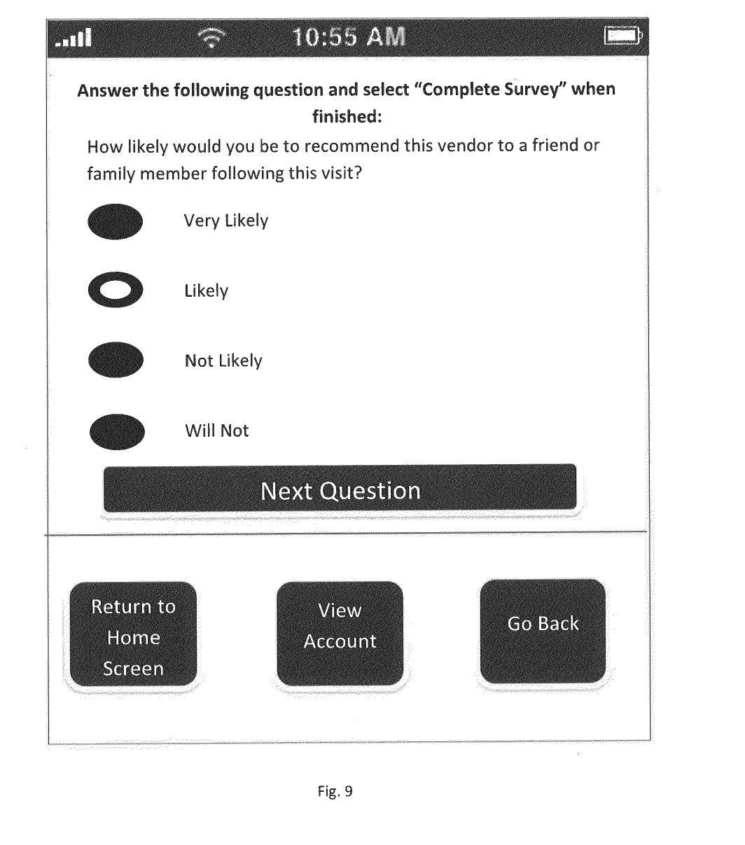

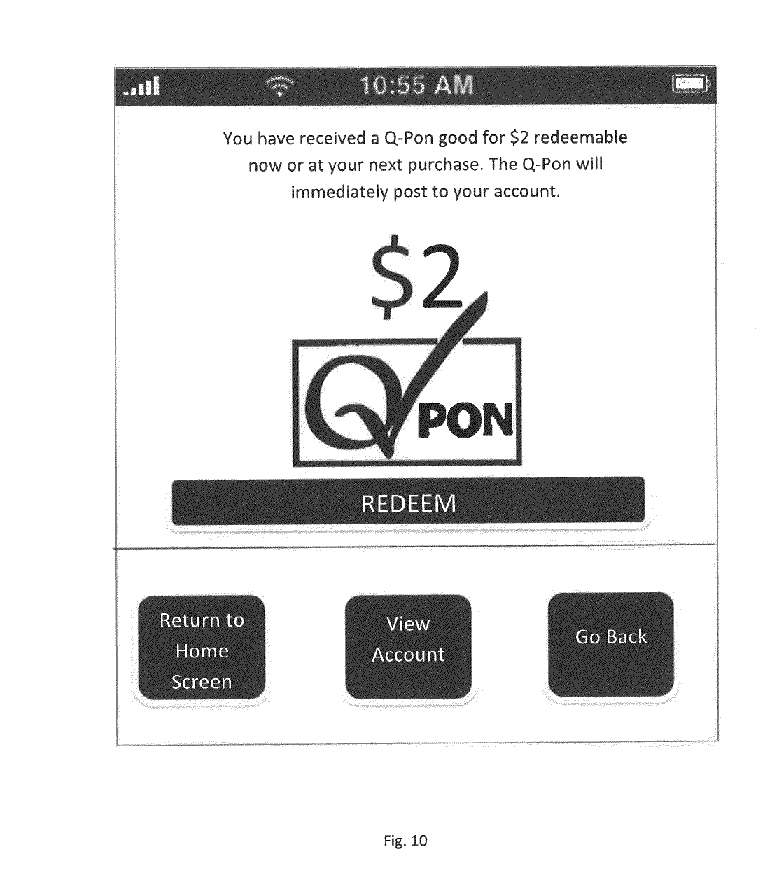

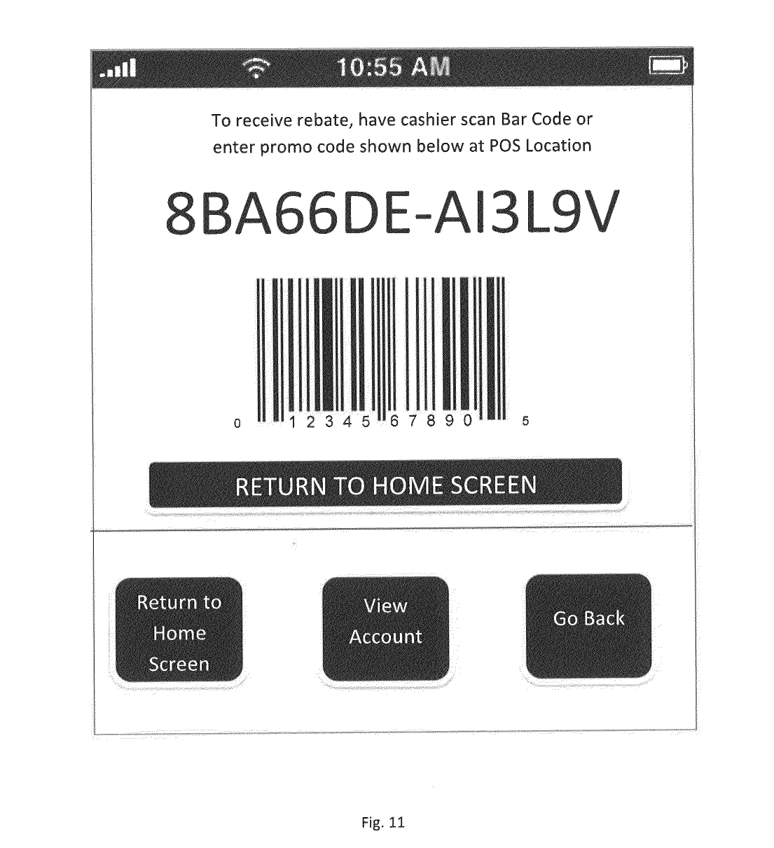

A process for performing review of a point-of-sale product or service is illustrated connection with FIGS. 2-11. A preferred embodiment of such a process sequence 100 is shown in FIG. 2 where a user, in connection with a purchase a point-of-sale, a user can select the review icon “QC Check” on a display of a wireless mobile device (see FIG. 3). The user can optionally select (FIG. 4) the type of scan or simply scans 104 a code at the point-of-sale with the wireless mobile device. The scanning step opens 106 the mobile device application. The mobile application can prompt the user to scan a code by displaying a message on the mobile device display (FIG. 5) or scan an RFID tag (FIG. 6). The display can then prompt the user on the mobile display (or by audio query) to provide a review (FIG. 7). The user can select a voice or text response. Selection of a text response results in the display (FIG. 8) of optional review responses that the user can select, such as “unsatisfactory,” “average,” “satisfactory,” or “exemplary.” The display can then immediately display compensation attributed to the user's account (FIG. 9) such as travel miles for a subsequent discount for airline travel. The display shown in FIG. 10 shows a compensation option that allows the user to immediately utilize the offer presented on screen. As shown in FIG. 11, this immediate redemption of the offer can be scanned at the point-of-sale.

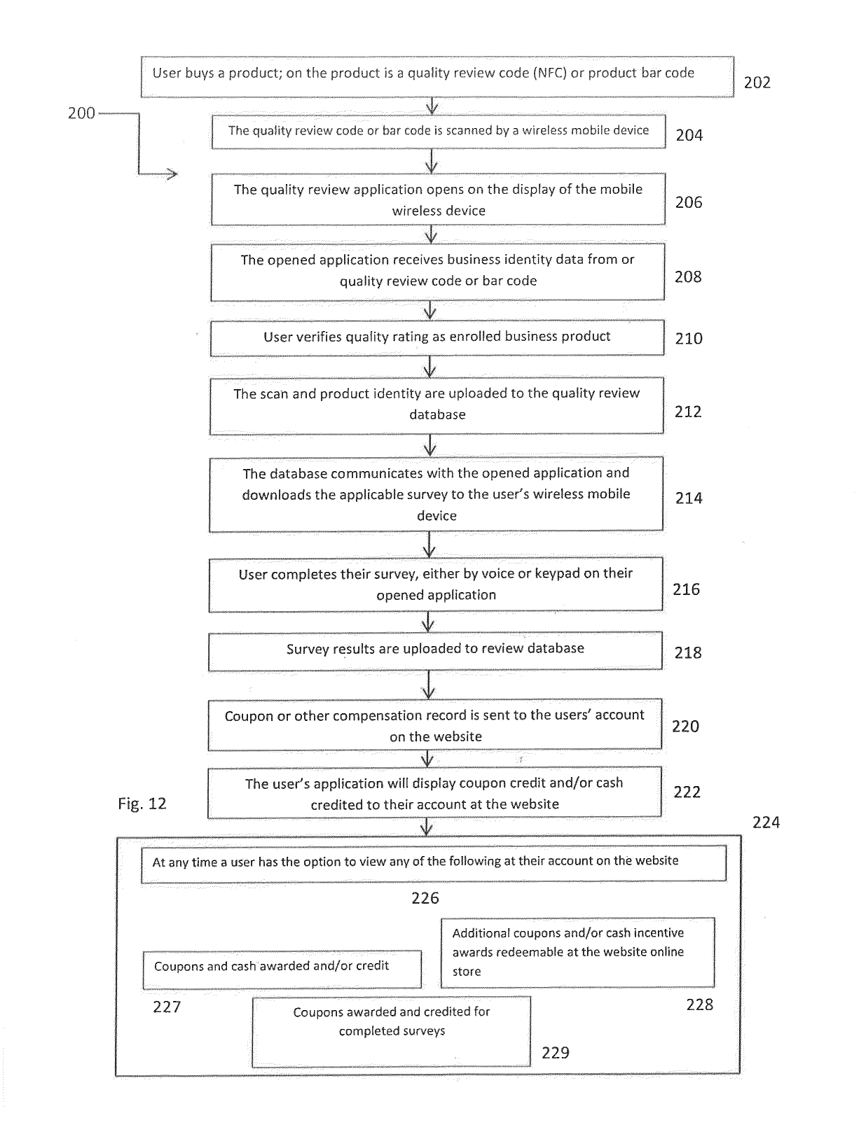

The process sequence shown in FIG. 12 illustrates the process 200 of performing a review of a consumer product that has been purchased 202 by a user. The user's wireless mobile device can be used to scan the code or tag as described previously herein on the product. The scanning process can open 206 the quality review application, which can display 208 the business icon, or otherwise identify the seller of the product. The user can select 210, the quality rating of the product or transaction, which is then transmitted 212 to the quality review database. A further question or survey can be transmitted 214 to the user which is then completed 216 and stored.

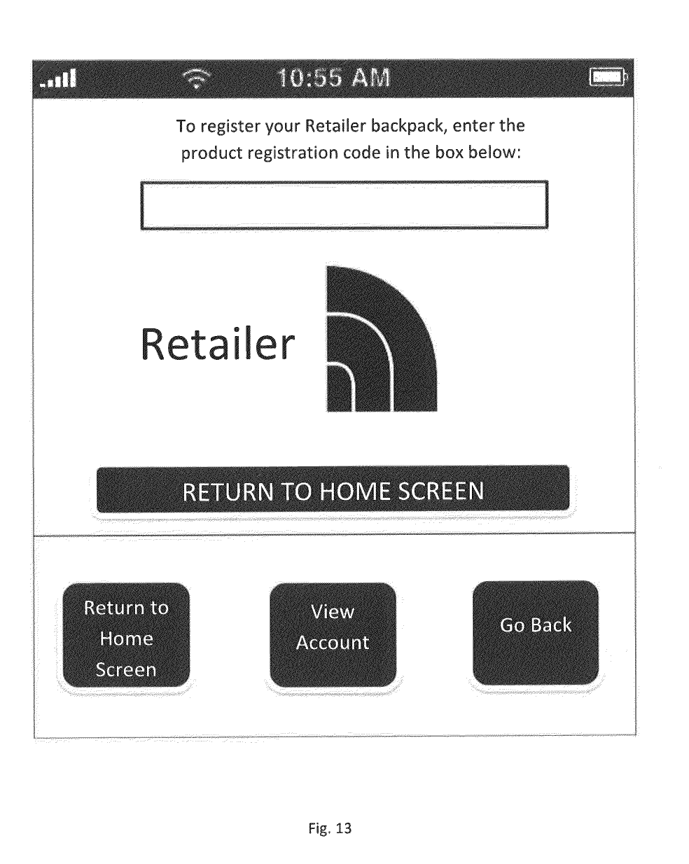

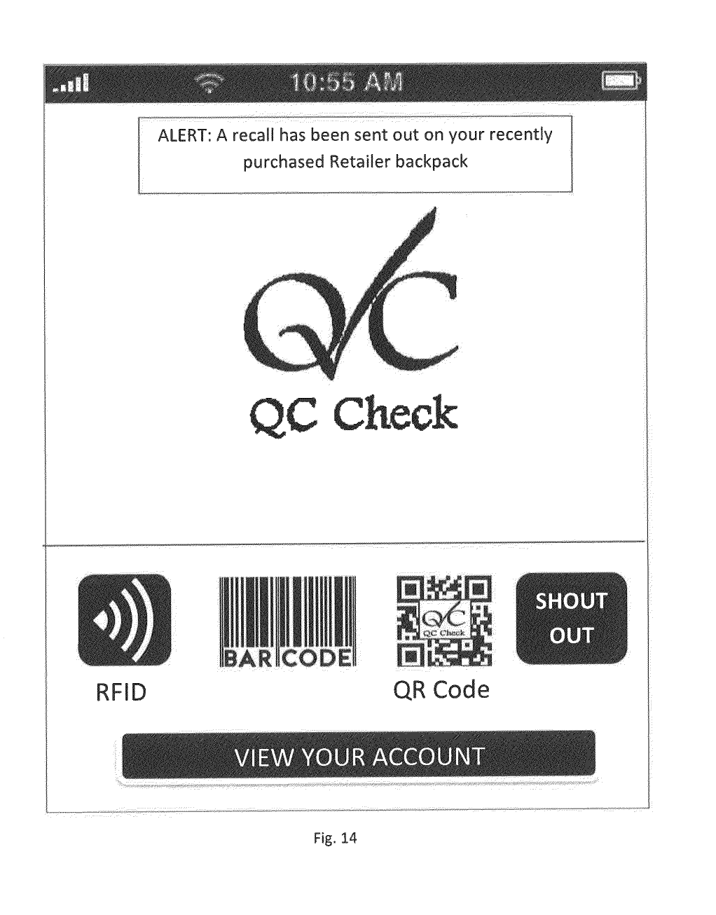

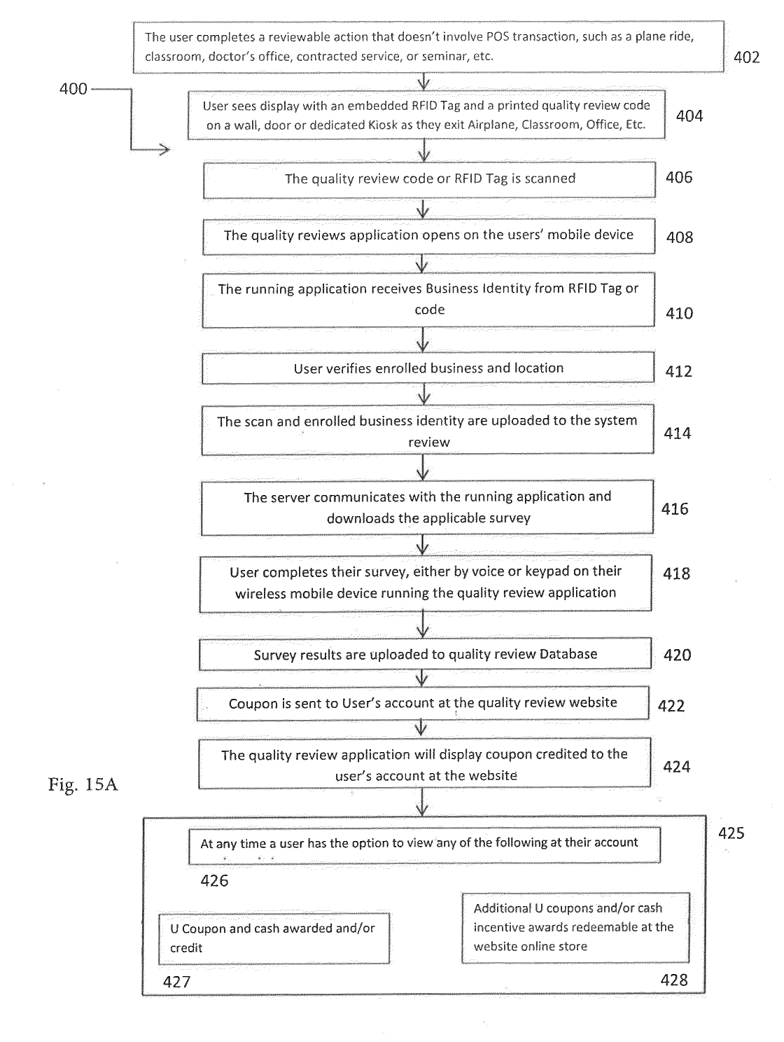

The survey results are then transmitted 218 to the review database. A compensation record for the review is transmitted 220 to the user's account and the result is displayed 222. The user can then access 224 their account and review 227, compensation records, review additional offers 228 or view the survey records 229. As shown in the screen display of FIG. 13, the application can also enable entry of a product code for registration, such as for warranty registration. Another option for the system application enables notification of a product purchaser or user of a product recall notice as shown in FIG. 14.

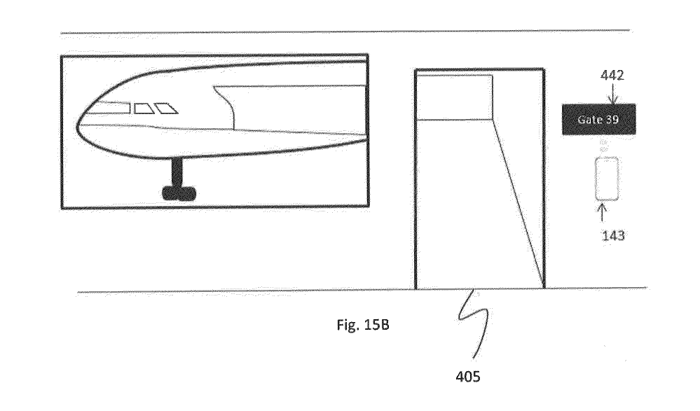

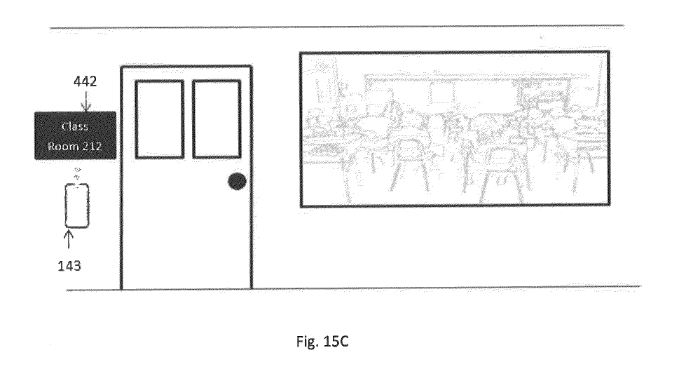

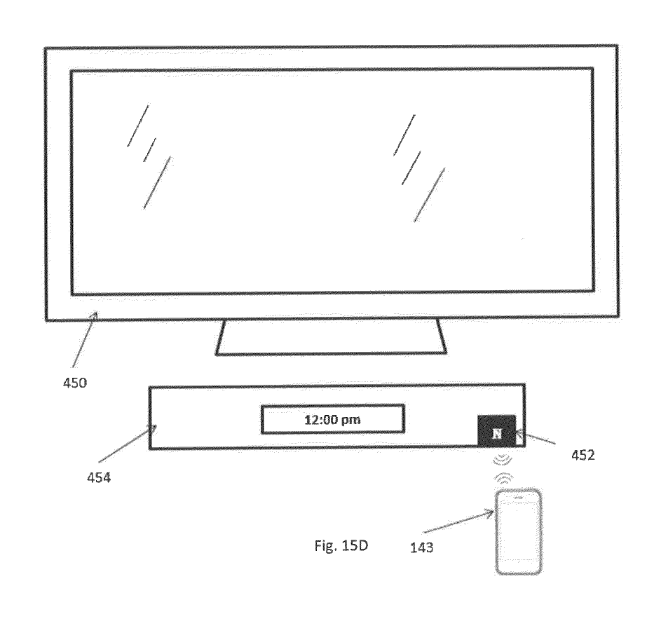

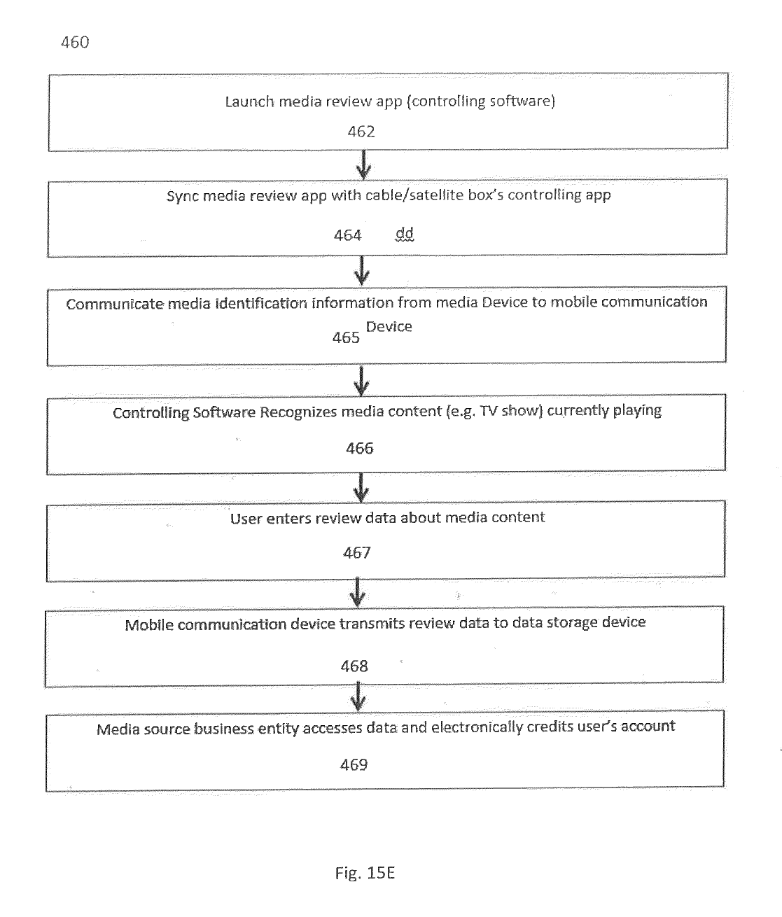

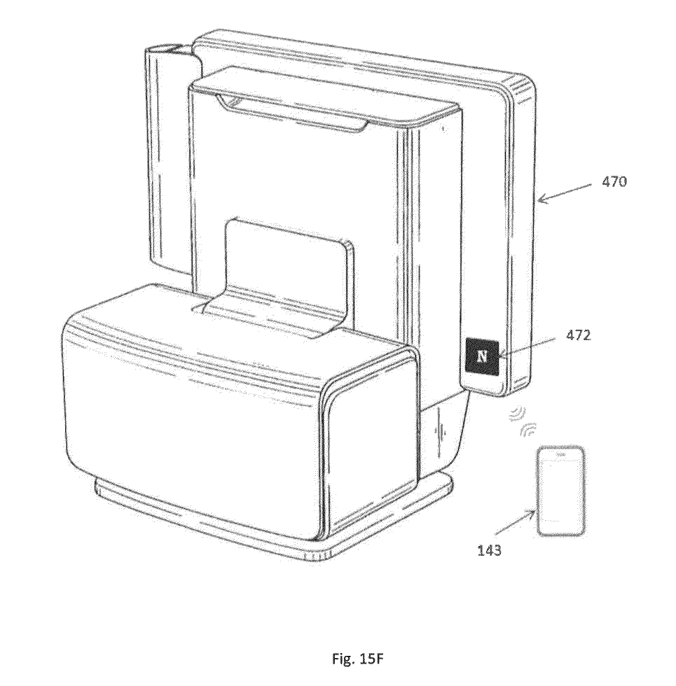

A preferred embodiment of a non-POS transaction sequence 400 is shown in FIG. 15A. In this process the user can employ their mobile communication device to scan a tag (RFID, NFC) or code at a location, such as at a gate 405 with a kiosk or sign 442 when departing after an airplane flight as shown in FIG. 15B, outside of a classroom or performance as shown in FIG. 15C, or other transaction 402 that may be associated with a non-POS location 404. After scanning 406, the application opens 408 and identifies the product or service 410 and verified enrollment 412. The scanned business identification data is transmitted to the system server 414 and the appropriate review screen or survey is transmitted 416 to the application running on the user's mobile device. The user completes the response 418 and transmits the review data to the review database 420. Compensation is then posted 422 to the user's account and this is also displayed 424 to the user on their mobile device. The user can also access 425 their account 426 information using the system website including any accumulated compensation features 427 and any other options 428 available.

Another preferred embodiment involves the user providing quality review of electronically delivered services in which the user receives electronically communicated information such as by electronic media to their mobile communication device, or by television transmission, satellite or cable connection. The user can review the services such as television programs, theatrical performances, movies, news programs, sporting events, advertisements, etc. The electronic media can include an identification code embedded therein that can be entered or scanned by the user. Such systems and methods can be implemented as shown in FIG. 15D in which a near field communication device 452 can be mounted to a video communication device 454, such as a cable box for a television 450 or an internet connection for a computer and display. A method for using this system is illustrated in connection with FIG. 15E. In this embodiment, the broadcast media source device can generate a program identification signal that is provided to the near field communication device so that scanning of the NFC device will properly identify the media content or program that is being watched to the scanning device that receives the identification data. The user can initiate the process by tapping the devices together or by using a near-field communication link to initiate the communication 462 on the user's mobile device. The appropriate media content identification data is conveyed 464 using the media device to prompt delivery 464 to the user's device, which also opens 465 the software application. The device recognizes 466 the media content to enable the interactive review process in which the user can enter 467 the review data. The mobile device then transmits 468 the review data to a storage device as described generally herein . The appropriate entity, such as the media source business, can then access 469 the data and can enable the electronic crediting of the user's account. Note that entities can also grade the review data provided so that users providing valuable feedback on a number of occasions can be rewarded. A preferred embodiment of the invention can use a plurality of servers that receive review data for separate businesses or industries so that media review data can be routed to separate servers, depending on the media source.

In another preferred embodiment, an RFID device 472 can be included in a television or computer device or display 470 so that the system in device 143 can be activated thereby as shown in FIG. 15F. In this embodiment, displayed electronic media such as television programs, advertisements, movies or broadcast live events, such as music or sporting events, can be reviewed be those watching the displayed media using their mobile communication device. A near field communication device that is accessible to those watching the displayed media can be scanned to identify the displayed media content so that the mobile communication device can retrieve from memory, or download by wireless network, a review format. The user can then enter review data and transmit the review data to a remote data storage device.

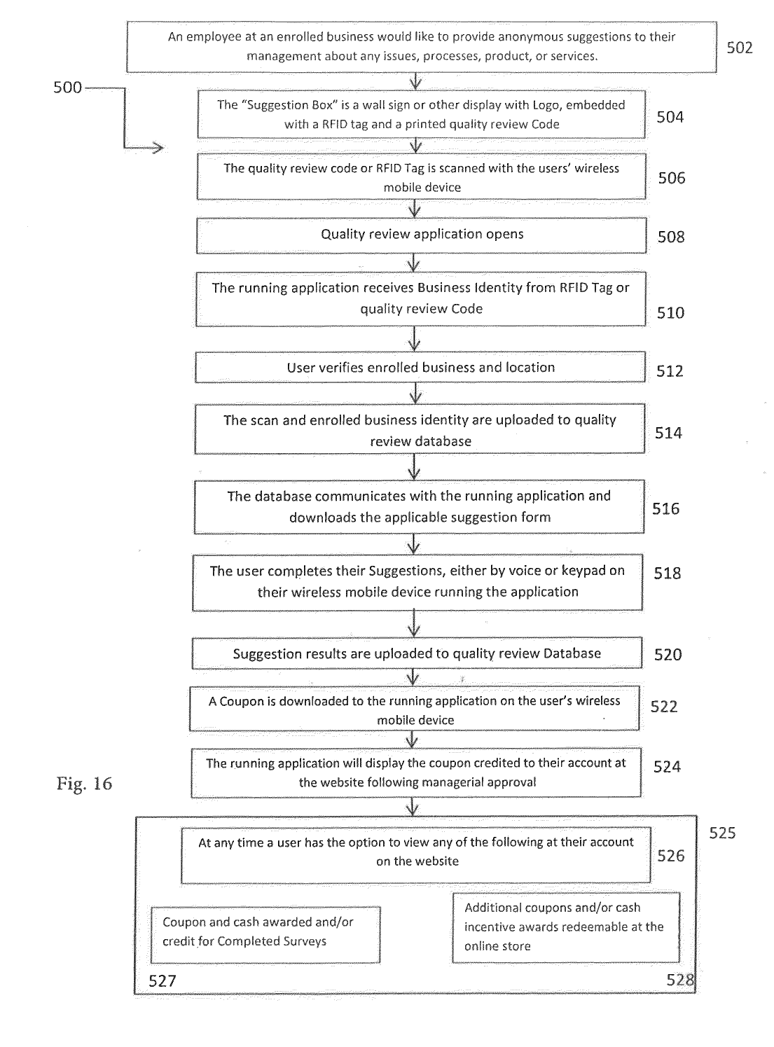

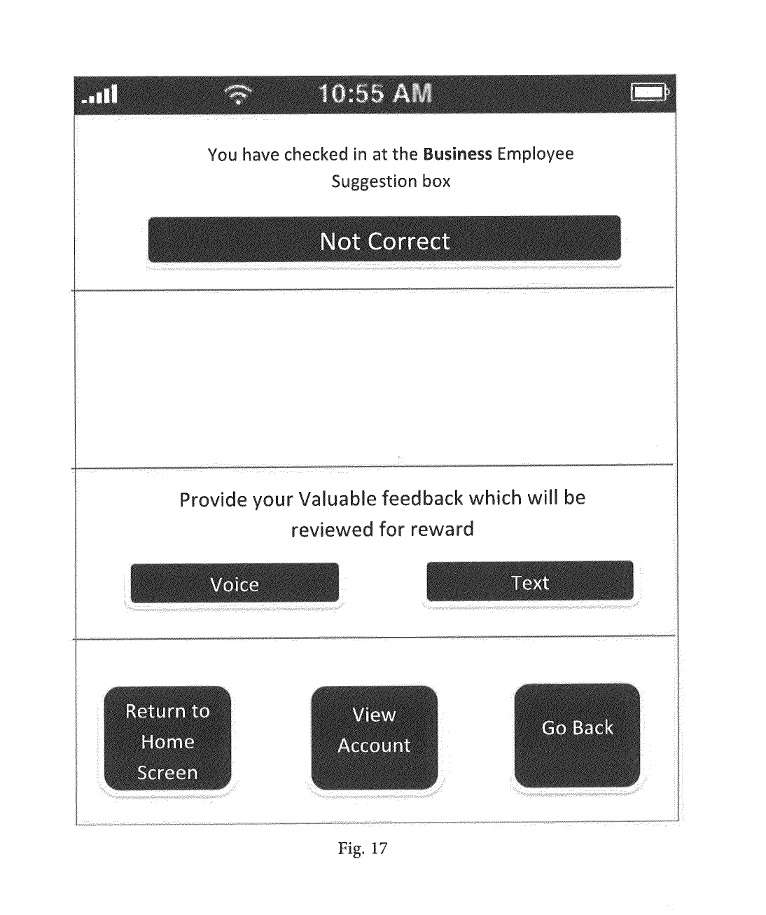

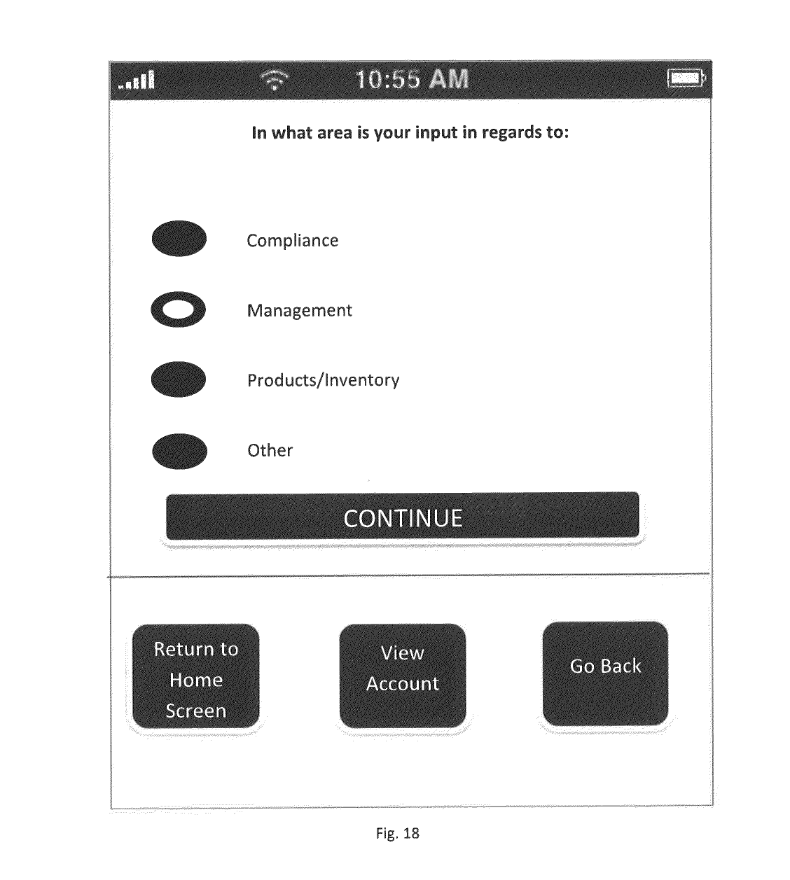

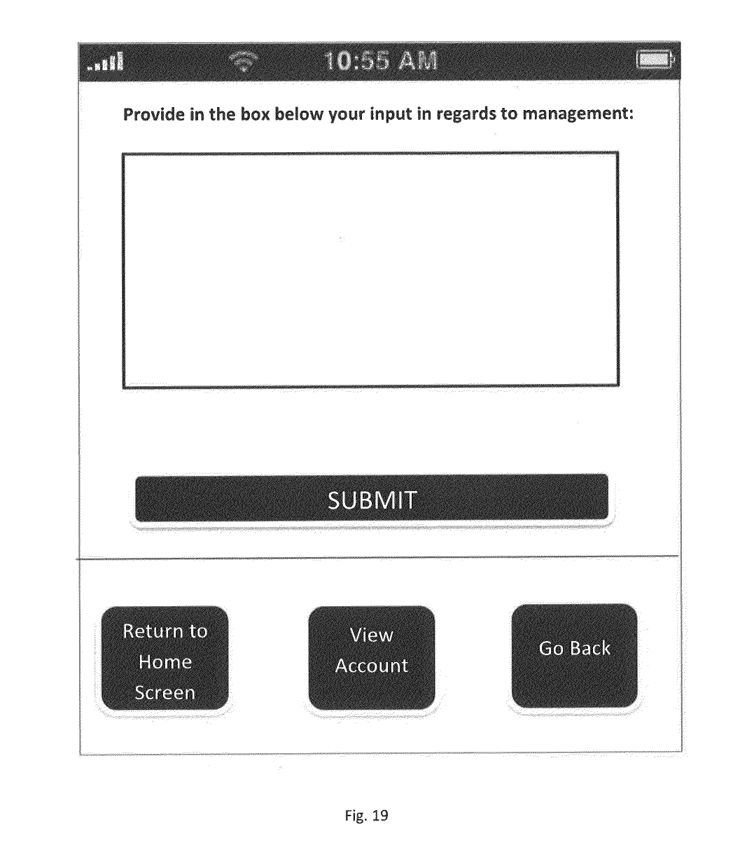

An employee review process 500 is illustrated in the sequence of FIG. 16. In this process the user can select 502 the review system icon on their mobile wireless device or a networked computer that can access the system server. The employee can identify 504 the employer business by entering a business identification code or by scanning 506 a display, kiosk, or tag associated with the business employer that can serve as an electronic “suggestion box.” This opens 508 the review application on the user device which can verify 510 the business identity. The user can then confirm 512 the business identity. The system server can then access the business quality review database 514 and transmits 516 the proper form to the users' device. As shown in FIG. 17, the user can select 518 the use of either voice or data entry formats. The system can optionally select a category list as shown in FIG. 18 so that the user can identify the proper format. The user then completes the review process 518 such as by entering a text description as shown in FIG. 19. The review data are then transmitted to the quality review database 520 and compensation can be transmitted to the users' device 522 subject to authorization 524. The user can also access 525 their account 525 to confirm compensation 527 or other options 528. The data from a particular user is tagged to identify the user and prevent misuse of the system by users.

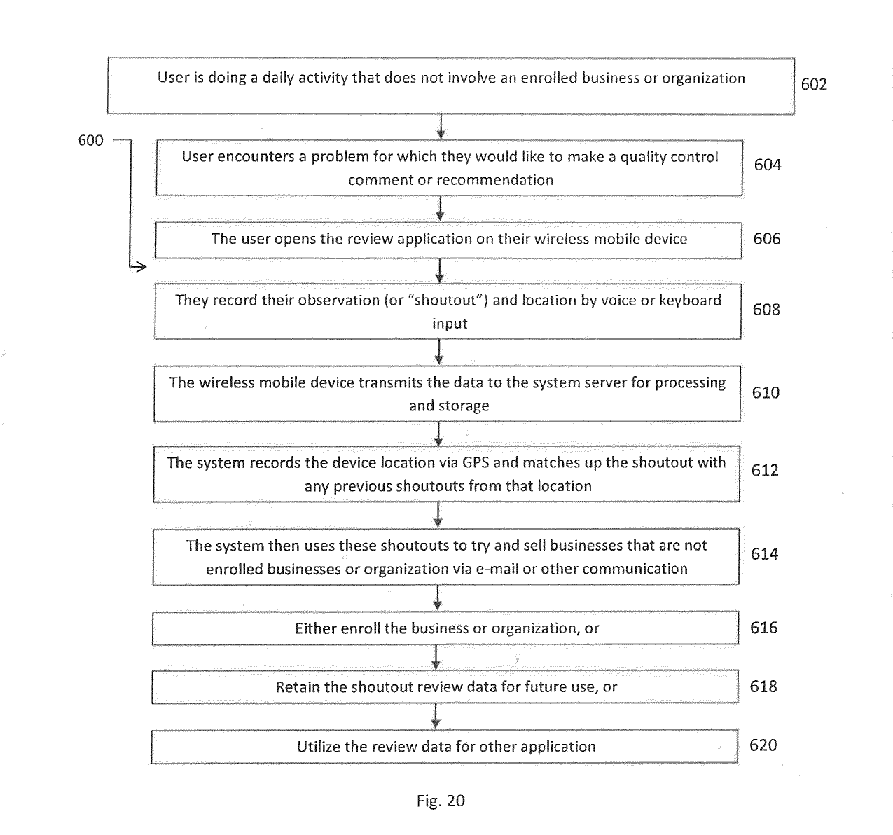

In another embodiment, the user can identify an un-enrolled business and provide a review 600 thereof using the process sequence of FIG. 20. In this embodiment, a user can identify 602 a business or entity that the user wishes to communicate 604 for the purpose of providing review data. The user opens the system application 606 and records review data by voice or text 608. The user's device transmits 610 the review data along with location 612 to the server for storage. The business then receives a communication from the system and is enrolled 616, or the data is retained 618 for later use with respect to that business or entity, or can be used by the review system operator for further application 620.

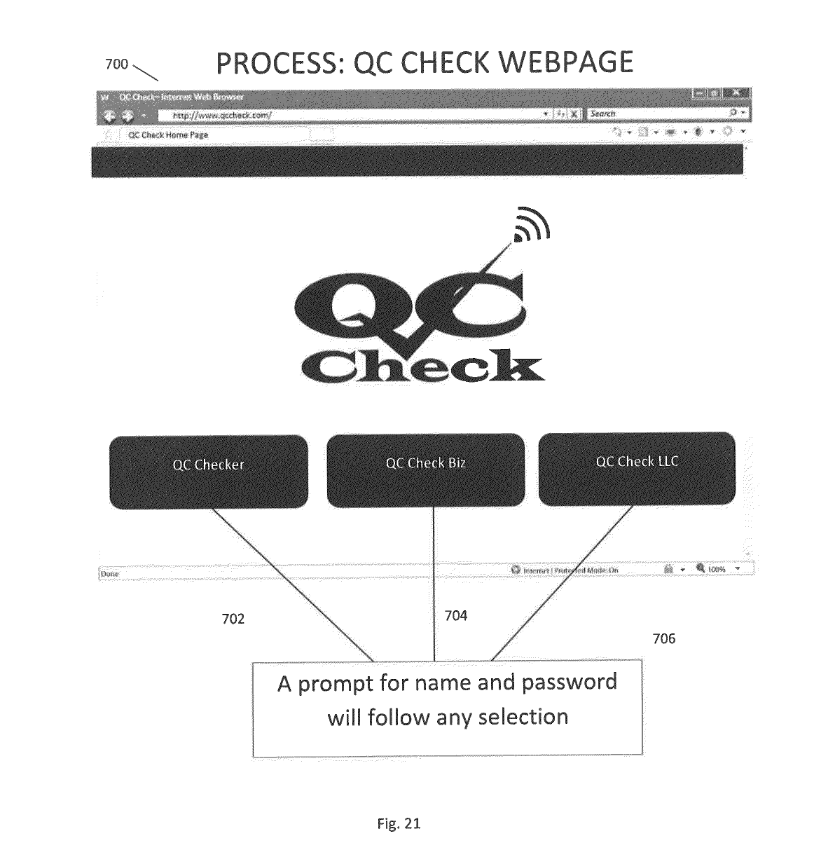

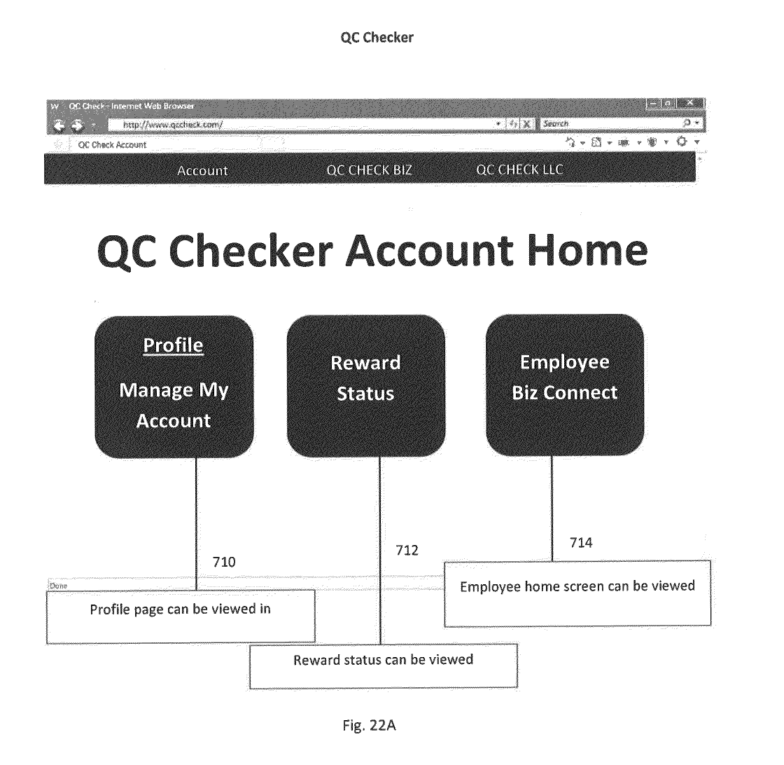

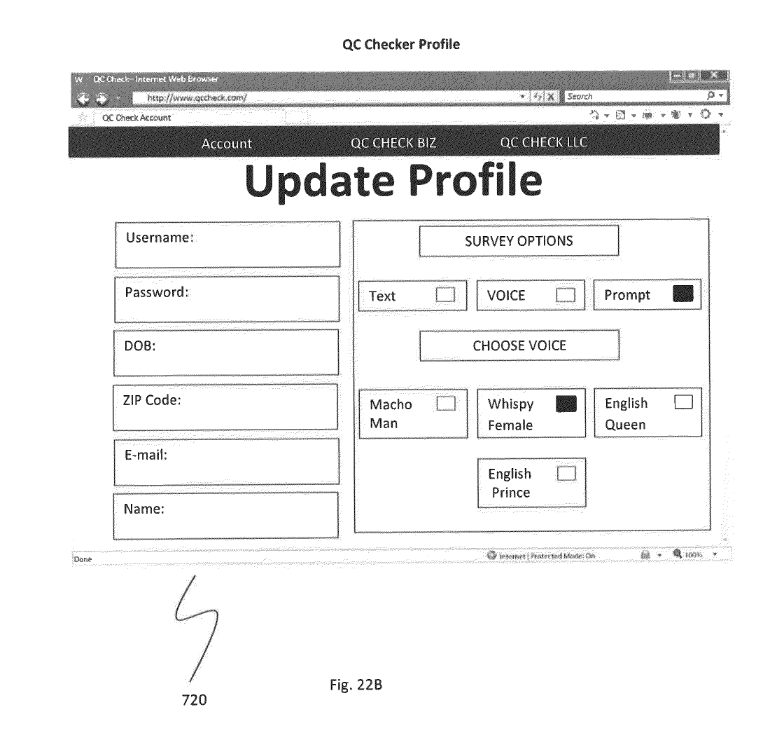

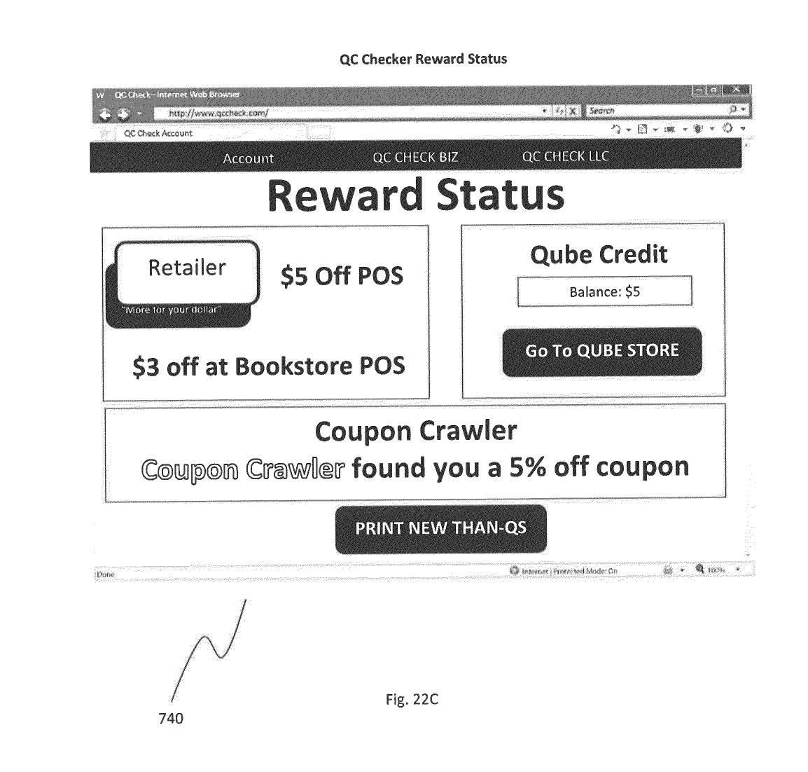

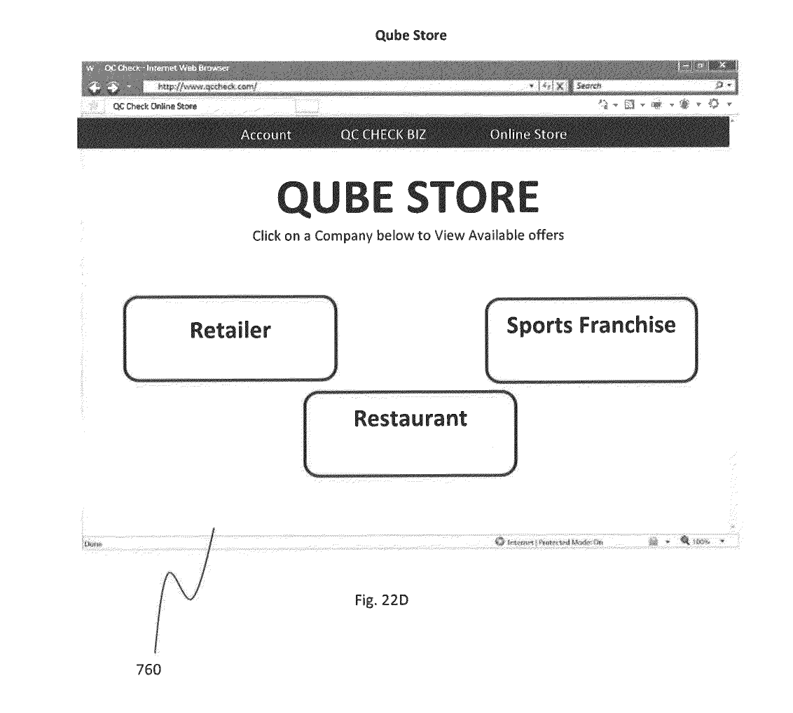

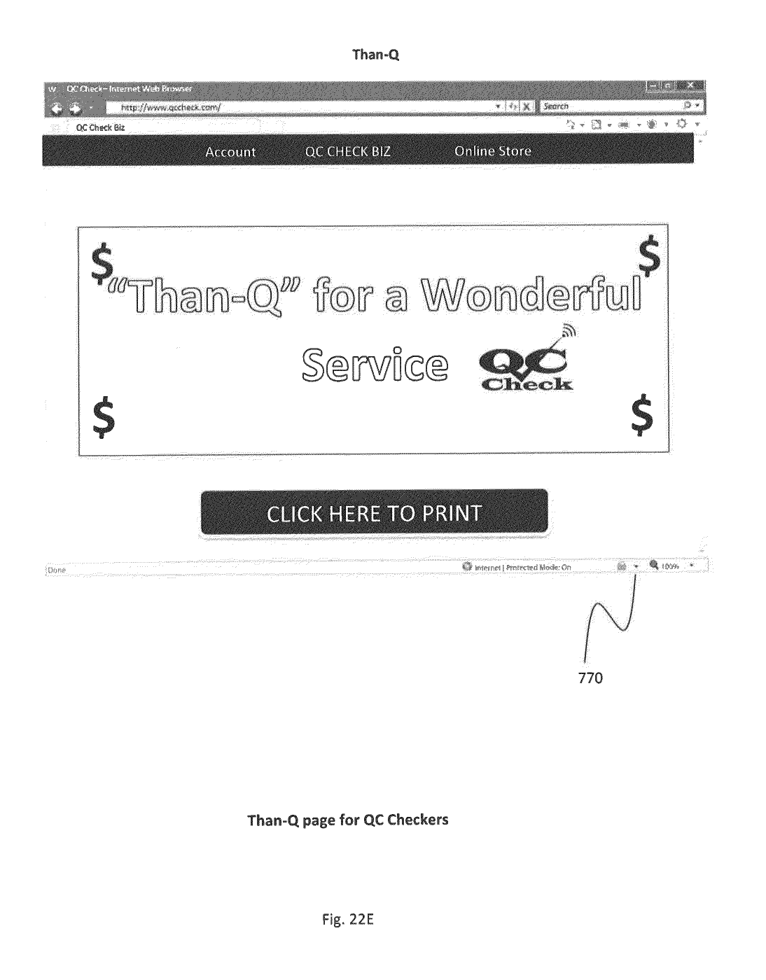

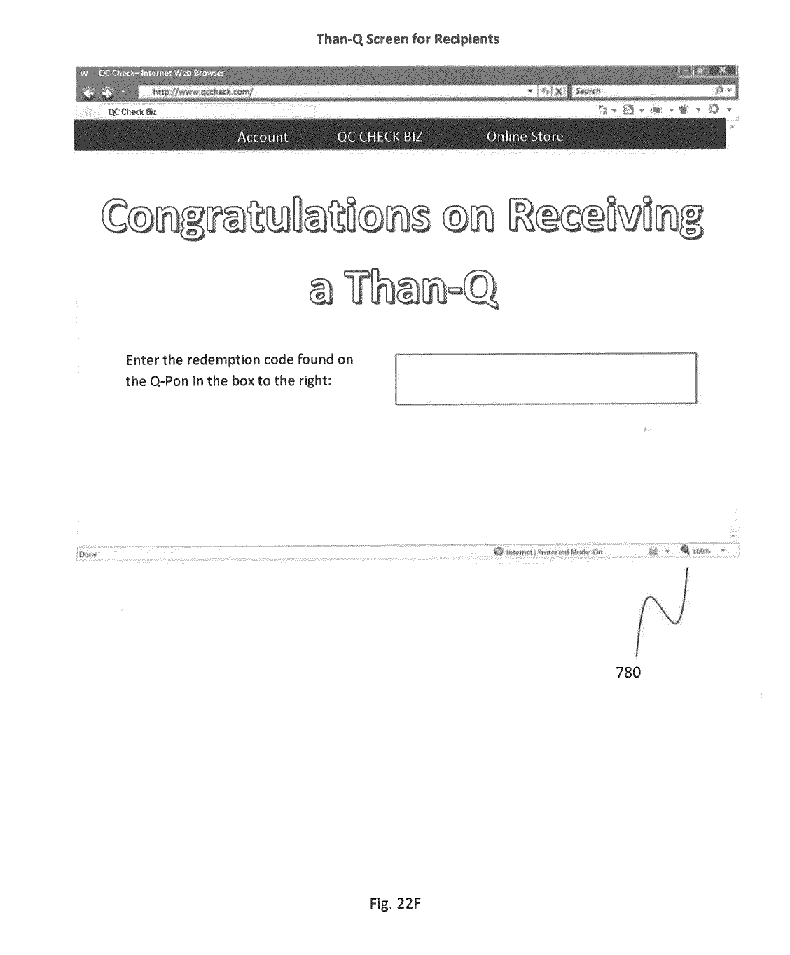

Shown in FIG. 21 is a display screen showing a system webpage 700 accessed by a user or business via computer display. Those using the system website can select the individual user account system 702, the business account system 704, or the review business system icon 706. A user selecting the user account icon 702, after entering a user name and password, will access a screen shown in FIG. 22A, where a user can select the profile and/or account page 710, a reward or compensation status page 712, or in the case of an enrolled business employee seeking to provide review data for their employer, the employee connection page 714. As shown in FIG. 22B, a user can update their profile page 720, or the reward status page 740 shown in FIG. 22C.

In a preferred embodiment the system can also include an online store 760 shown in the page of FIG. 22D. The system can also enable the user to access and print a coupon 770, shown in FIG. 22E, that a user can use at enrolled businesses in exchange for products or services. The user can enter a redemption code using the screen 780 shown in FIG. 22F where the code has been retrieved from a coupon.

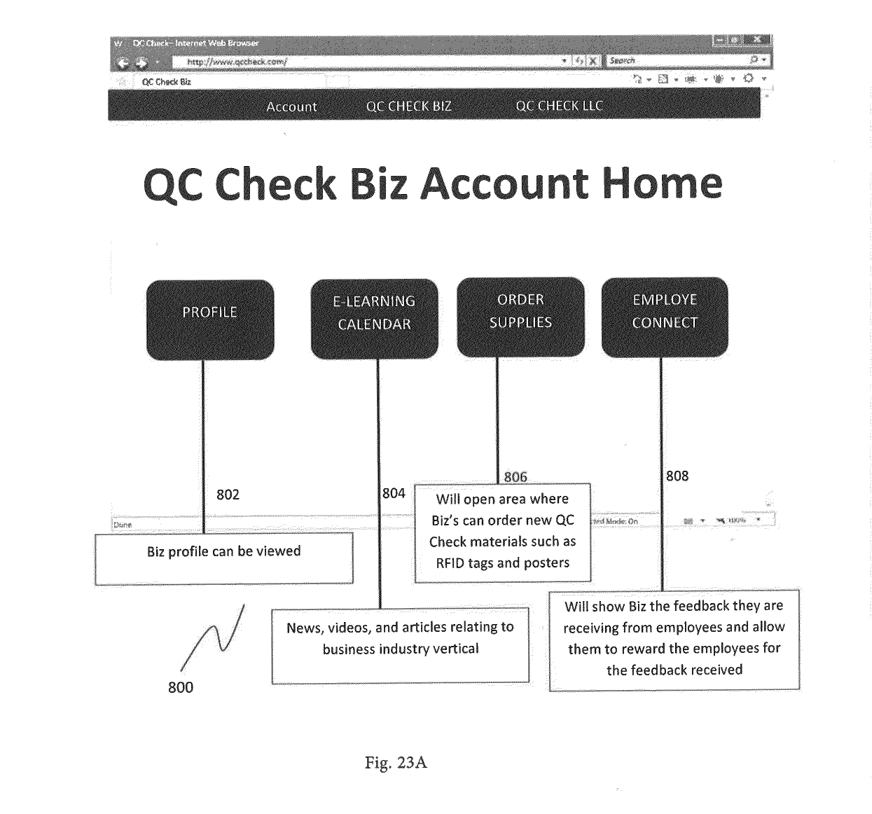

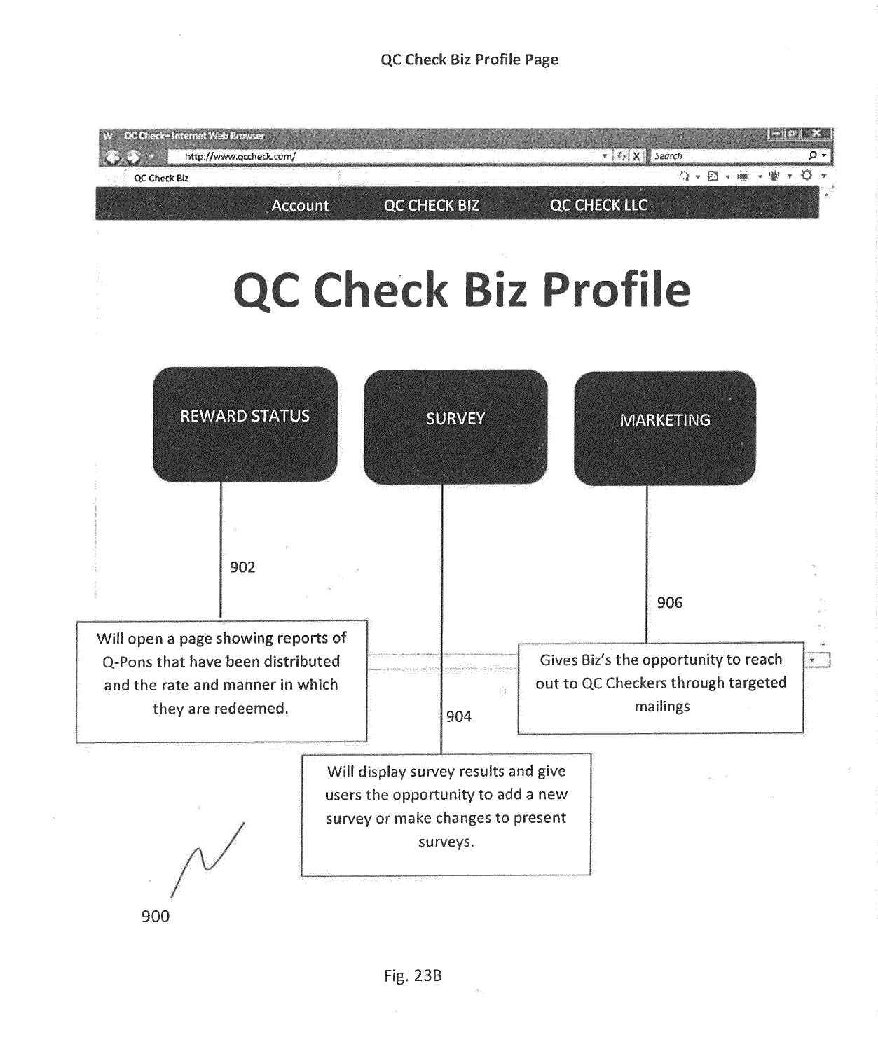

An example of a business account webpage 800 is illustrated in FIG. 23A. The business can access and modify its profile 802, can access an e-learning portal 804 including a calendar and e- learning files provided by the business, a supply portal 806 and an employee connection portal 808. The business profile page 900 enables a business to access reward data 902, review data 904, and market analysis data 906 and provide direct marketing access to users for marketing purposes.

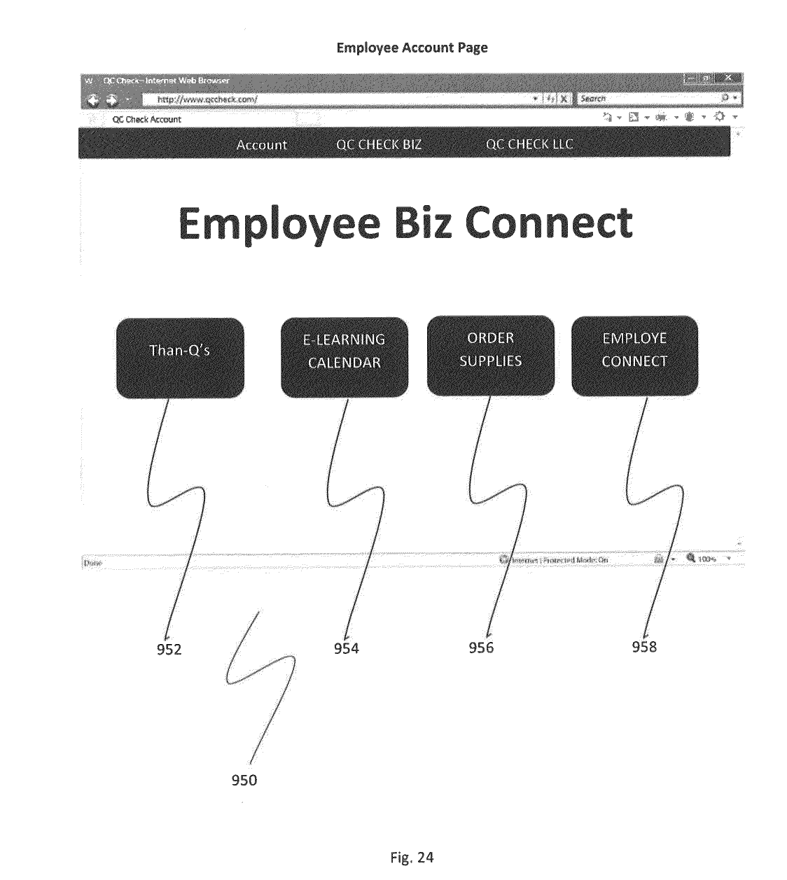

When an employee selects the employee connect page 950, as shown in FIG. 24, the employee can access reward details 952 provided by the employer, e-learning files 954 or, alternatively, the employee can access employer news 956 or website access 958 to the employer or other retail websites.

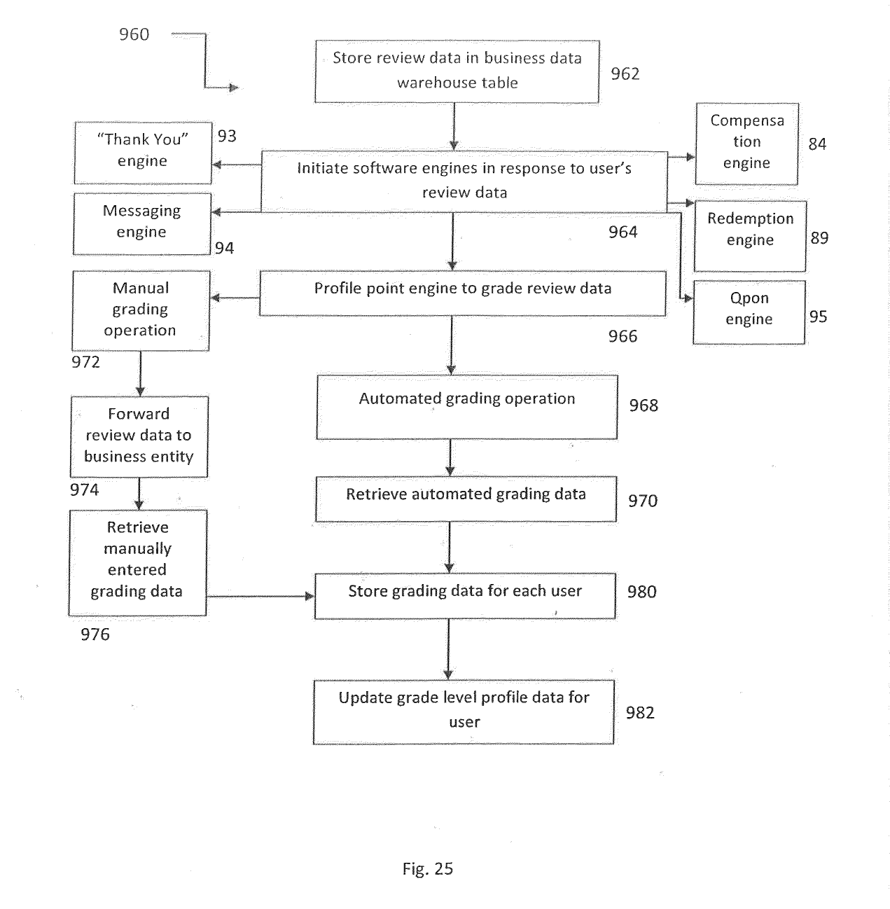

Illustrated in connection with FIG. 25 are methods for post-review processing 960 in accordance with preferred embodiments of the invention. After review data has been stored into a memory, the system can actuate a number of operations such as export into a data warehouse of a business entity for storage and reporting operations 962. The system can also initiate a plurality of distinct operations depending upon the content of the review data and the operations selected by the particular entity to incorporate into its review data processing menu. The menu of operations can include the compensation protocol 84 in which users are rewarded in accordance with a compensation formula defined by the entity. The menu of operations can also include, redemption 89, coupon 95, “thank you” or electronic acknowledgment 93, messaging 94 and a profile point feature 966 described in greater detail.

Profiling of a user can include a point system based on the grading of review data by the particular entity being reviewed. As participating entities value accurate and detailed feedback regarding both good and poor aspects of the user's transaction experience, the more users are encouraged to participate, the more valuable the information obtained. Certain kinds of review data is easily quantified and automated, such as frequency of review data entry with entrees made in a digitized format (e.g. quality graded on a 1-10 scale). Other review data, such as a detailed summary in words that requires review by a business representative who must access and read the word description of a transaction contained in the review data. Review data requiring such review is referred to herein as a manual grading operation.

Thus, the process 960 includes a grading process that is either fully automated 968 or has at least one data element requiring manual review 972. Manual review requires forwarding 974 of the review data, such as a text message, to an entity designated to perform manual entry who then performs manual entry for retrieval 976 by the system. Similarly, automatically graded data is also retrieved 970 and the grading data is then stored for each user 980. The grading level for the user is then updated based on the grading operation(s) 982. This grading update can then be used to alter the user's status, such as the compensation formula or adjusting other reward attributes such as providing other redemption or coupon options.

The following should not be read as being limited to the order or elements unless expressly stated. The embodiments of the invention described herein that are within the scope and spirit of the following claims and equivalents thereof are claimed as the invention.

What is claimed is:

1. A computer implemented method of performing a review of a business transaction comprising:
actuating a wireless mobile device to execute a program operative to enable a user to review a transaction with an entity;
recording review data regarding the transaction using the wireless mobile device, the review data including entity identification data and transaction data;
transmitting the review data from the wireless mobile device to a data storage device, the review data being associated with a user account of the user; and
accessing the user account using a communication network, the user account including compensation data wherein compensation is attributed to the user account in response to receipt of the review data.

2. The method of claim 1 further comprising storing enrolled business entity data for a plurality of business entities in a data storage device.

3. The method of claim 1 wherein the step of recording review data using a wireless mobile device further comprises operating a cellular telephone having a display.

4. The method of claim 3 further comprising accessing a public access network using the cellular telephone.

5. The method of claim 1 further comprising actuating the wireless mobile device at a point-of-sale to record review data.

6. The method of claim 1 further comprising recording review data for a business transaction including a purchase of a product by the user.

7. The method of claim 1 further comprising using the wireless mobile device to scan a product identity code.

8. The method of claim 1 further comprising scanning a business identity code at a scanning location with the wireless mobile device to record business identity data.

9. The method of claim 1 further comprising reviewing a service provided by a business entity.

10. The method of claim 1 further comprising performing a review of a business entity by an employee of the business entity.

11. The method of claim 1 further comprising performing a review of an unenrolled business entity.

12. The method of claim 1 further comprising identifying the entity using a near field communication device mounted within the wireless mobile device.

13. The method of claim 12 further comprising positioning the wireless mobile device in proximity to an RFID device to identify a geographic location of the transaction.

14. The method of claim 1 wherein the recording step comprises using a voice activated process to record review data of a transaction.

15. The method of claim 1 wherein the recording step comprises entering review data with a touchscreen display.

16. The method of claim 1 further comprising downloading a review format associated with the entity.

17. The method of claim further comprising transmitting review data to a server connected to the data storage device.

18. The method of claim 1 further comprising recording review data in a storage location assigned to an entity account associated with the entity.

19. The method of claim 18 further comprising accessing the entity account and generating a report based on the review data.

20. The method of claim 1 further comprising grading the review data and updating a user profile based on graded review data.

21. The method of claim 20 wherein review data is graded automatically.

22. The method of claim 20 wherein the review data is graded manually.

23. The method of claim 20 wherein the graded review data generates updated profile data and a compensation category is updated for a user.

24. The method of claim 1 further comprising actuating a virtual icon on a display of the wireless mobile device to actuate the program to display a review format.

25. A system for reviewing transactions with a business entity comprising:
a data storage system that stores user account data and enrolled business data, the data storage system receiving transaction review data using a wireless network;
a server system accessed using a public access network, the server operating a plurality of engine modules including a survey engine that delivers review formats with the wireless network to one or more mobile wireless devices; and
a plurality of scannable coded locations, each scannable coded location being associated with a business entity location and having a business entity location code that can be scanned by a mobile wireless device.

26. The system of claim 25 wherein the survey engine correlates one or more review formats with each of a plurality of enrolled business entities.

27. The system of claim 25 wherein the server system further comprises a compensation engine to attribute user accounts with compensation for review.

28. The system of claim 25 further comprising a near field communication device associated with a plurality of enrolled business locations.

29. The system of claim 25 wherein each mobile wireless device comprises a data processor and a memory having stored therein instructions to execute a software application.

30. The system of claim 25 further comprising an account management engine.

31. The system of claim 25 further comprising a reporting engine.

32. The system of claim 25 wherein the data storage system comprises a data warehouse.

33. The system of claim 29 wherein each wireless mobile device comprises a display and a near field communication device.

34. The system of claim 32 further comprising a report builder engine that accesses data stored in the data warehouse.

35. The system of claim 25 wherein the server system further comprises a messaging engine.

36. The system of claim 25 wherein the server system further comprises a profile point engine.

37. The system of claim 25 wherein the server system further comprises a coupon engine.

38. The system of claim 25 wherein the server system further comprises a learning engine.

39. The system of claim 25 wherein the server system further comprises an identification tagging engine.

40. The system of claim 25 wherein the data storage system further comprises a data storage medium on which is stored at least one review format for a business entity, the business entity being associated with a business account.

41. The system of claim 40 wherein each business entity associated with a business account comprises an enrolled business.

42. The system of claim 41 wherein enrolled business data is associated with review data stored in the data storage system for each enrolled business.

43. The system of claim 25 wherein each scannable coded location comprises a near field communication device.

44. The system of claim 43 wherein the near field communication device comprises an RFID device.

45. A system for reviewing business transactions comprising:
a data storage system for storing user account data and enrolled business data, the data storage system receiving transaction review data using a public access network;
a server system accessed using the public access network, the server operating a plurality of engine modules including a survey engine that delivers review formats with the public access network to one or more computing devices, each computing device being connected to a near field communication circuit.

46. The system of claim 45 wherein the survey engine correlates one or more review formats with each of a plurality of enrolled business entities.

47. The system of claim 45 wherein the server system further comprises a compensation engine to attribute user accounts with compensation for review.

48. The system of claim 45 further comprising a near field communication device associated with a plurality of enrolled business locations of a business entity.

49. The system of claim 45 wherein each mobile wireless device comprises a data processor and a memory having stored therein instructions to execute a software application.

50. The system of claim 49 wherein the software applications further comprises a user interface to record review data.

51. A computer implemented method for reviewing electronically displayed media comprising:
displaying electronic media on an electronic display associated with a near field communication device;
positioning a mobile wireless device in proximity to the near field communication device to transfer an identification code from the device to the mobile communication device, the identification code identifying the displayed electronic media;
entering review data regarding the displayed electronic media on the mobile communication device; and
transmitting the review data from the mobile communication device with a wireless network to a data storage device.

52. The method of claim 51 further comprising displaying a review format on a display of the mobile communication device, the review format being associated with the displayed electronic media.

53. The method of claim 51 further comprising downloading a review format with the mobile communication device.

54. The method of claim 52 further comprising entering review data with a graphical user interface on the mobile communication device.

55. The method of claim 51 further comprising actuating an icon on the mobile communication device to open a system software application.

56. The method of claim 51 wherein the mobile communication device comprises a cellular telephone.

57. The method of claim 51 wherein the mobile communication device comprises a tablet computing device.

58. The method of claim 51 wherein the mobile communication device comprises a laptop computer.

59. The method of claim 51 wherein the review data is transmitted to a system server having a plurality of user accounts.

60. The method of claim 51 further comprising a system server having a plurality of business entity accounts.
